(19) United States
(12) Patent Application Publication
(10) Pub. No.: US 2026/0088942 A1
(43) Pub. Date: Mar. 26, 2026

(54) METHOD AND APPARATUS FOR AVOIDING UNNECESSARY WIRELESS TRANSMISSIONS

(71) Applicant: Sharp Kabushiki Kaisha, Osaka (JP)

(72) Inventors: Sangkyu BAEK, Vancouver, WA (US); Atsushi ISHII, Vancouver, WA (US)

(21) Appl. No.: 18/898,231

(22) Filed: Sep. 26, 2024

(51) Int. Cl. H04L 1/1867

(52) U.S. Cl. CPC H04L 1/1887; H04L 1/189

(57) ABSTRACT

A transmitter node of a telecommunications system comprises a retransmission counter and processor circuitry. The retransmission counter is configured to store a value indicative of a number of retransmissions of a packet from the transmitter node to a receiver node of the telecommunications system. The processor circuitry configured to affect the value of the retransmission counter for the packet when the packet is determined to be an obsolete packet. Methods of operating such nodes are also provided.

### TECHNICAL FIELD

The technology relates to wireless communications, and particularly to the avoidance of unnecessary wireless transmissions including radio link control (RLC) acknowledged mode (AM) transmissions.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

The Open Systems Interconnection, OSI, model is a reference framework that explains the process of transmitting data between computers. It is divided into seven layers that work together to carry out specialized network functions, allowing for a more systematic approach to networking. Information transferred from one device to another device travels through 7 layers of OSI model. First data travels down through 7 layers from the sender's end and then climbs back 7 layers on the receiver's end. Data flows through the OSI model in a step-by-step process:
Layer 7: Application Layer: Applications create the data.
Layer 6: Presentation Layer: Data is formatted and encrypted.
Layer 5: Session Layer: Connections are established and managed.
Layer 4: Transport Layer: Data is broken into segments for reliable delivery.
Layer 3: Network Layer: Segments are packaged into packets and routed.
Layer 2: Data Link Layer: Packets are framed and sent to the next device.
Layer 1: Physical Layer: Frames are converted into bits and transmitted physically.

A protocol stack may comprise different individual protocols. Protocols may be simply described as set of rules that allow communication between peer entities or they can also be described as set of rules that facilitate horizontal communication. These protocols may be arranged in the layers such as those described above. In a transmitter side, a layer N receives data from layer N+1 and this data is called the SDU or Service Data Unit. This layer will modify the data and convert it into a PDU or a Protocol Data Unit. The peer entity in the receiver is only able to understand this PDU. In the receiver side, the peer entity receives the PDU from layer N−1, e.g., actually layer N−1 SDU, and converts it back into SDU(s) and passes it to layer N+1.

Radio Link Control (RLC) is a layer 2 Radio Link Protocol used in UMTS, LTE and 5G on the Air interface. This protocol is specified by 3GPP in TS 25.322 for UMTS, TS 36.322 for LTE and TS 38.322 for 5G New Radio (NR). RLC is located on top of the 3GPP MAC-layer and below the PDCP-layer. The main tasks of the RLC protocol are:
Transfer of upper layer Protocol Data Units (PDUs) in one of three modes: Acknowledged Mode (AM), Unacknowledged Mode (UM) and Transparent Mode (TM)
Error correction through ARQ (only for AM data transfer)
Segmentation and reassembly of RLC SDUs (UM and AM)
Re-segmentation of RLC data PDUs (AM)
Reordering of RLC data PDUs (UM and AM)
Duplicate detection (UM and AM)
RLC SDU discard (UM and AM)
RLC re-establishment
Protocol error detection and recovery

The Radio Resource Control (RRC) plays a role in managing the radio resources between the User Equipment (UE) and the 5G New Radio (NR) network.

In 3GPP New Radio (NR) standards, the Radio Link Control (RLC) sublayer supports reliable transmission based on an Automatic Repeat reQuest (ARQ) mechanism. RLC has three modes, namely (1) a Transparent Mode (TM), (2) an Unacknowledged Mode (UM) and (3) an Acknowledged Mode (AM). In the RLC AM mode, 100% successful delivery is guaranteed by multiple retransmissions. To guarantee 100% successful delivery, retransmissions should be performed even if the packet is already outdated, i.e., even if the packet was generated a long time ago, in which case it does not need to be processed at the destination or intermediate node. Retransmission of an outdated, e.g., obsolete packet, can be an inefficiency of RLC AM.

There has been some discussion in 3GPP RAN2 to improve the inherited inefficiency of RLC AM to avoid the unnecessary transmission and retransmission of an obsolete service data unit (SDU) including outdated packets. Thus far a basic requirement of any such improvement is that both a transmission window and a reception window should be synchronized. Thus, the transmission status at transmitter, TX, and a reception status at receiver, RX, should be shared by some mechanisms such as an Obsolete SDU Indication, polling, a modification of status report information, and so on.

RLC AM is related to a radio link failure (RLF) procedure. If the maximum number of retransmission (RETX_COUNT in 3GPP 38.322) is reached, an RLC entity indicates this information to the upper layer, e.g., the Radio Resource Control (RRC), to declare RLF and perform RRC Re-establishment procedure. In 3GPP 38.322, such maximum number of retransmissions may be maintained by a counter RETX_COUNT. Thus, RLC AM enhancement should also support a count-based RLF declaration mechanism

What is needed are methods, apparatus, and/or techniques to address problems caused by or associated with one or more inefficiencies of radio link control (RLC) transmissions.

### SUMMARY

In a first of its example aspects the technology disclosed herein concerns a transmitter node of a telecommunications system. In an example embodiment and mode the transmitter node comprises a retransmission counter and processor circuitry. The retransmission counter is configured to store a value indicative of a number of retransmissions of a packet from the transmitter node to a receiver node of the telecommunications system. The processor circuitry configured to affect the value of the retransmission counter for the packet when the packet is determined to be an obsolete packet. Methods of operating such nodes are also provided.

In a second of its example aspects the technology disclosed herein concerns a transmitter node of a telecommunications system. In an example embodiment and mode the transmitter node comprises interface circuitry and processor circuitry. The interface circuitry is configured to receive a status message over a radio interface from a receiver node regarding a packet. The processor circuitry is configured to make a determination that both (1) the status message indicates that the packet was not received from the receiver node; and (2) the packet is considered to be an obsolete packet; and, in accordance with the determination, to generate an obsolete packet indication message that identifies the packet as the obsolete packet. The interface circuitry is further configured to transmit the obsolete service data unit indication message that identifies the packet as the obsolete service data to the receiver node. Methods of operating such nodes are also provided.

In a third of its example aspects the technology disclosed herein concerns a transmitter node of a telecommunications system. In an example embodiment and mode the transmitter node comprises interface circuitry and processor circuitry. The processor circuitry is configured to include a polling request in an obsolete packet indication message for an obsolete packet. The interface circuitry is configured to transmit the obsolete packet indication message over a radio interface to a receiver node of the telecommunications system. Methods of operating such nodes are also provided.

In a fourth of its example aspects the technology disclosed herein concerns a receiver node of a telecommunications system. In an example embodiment and mode the receiver node comprises interface circuitry and processor circuitry. The interface circuitry is configured to receive packets over a radio interface from a transmitter node of the telecommunications system. The processor circuitry is configured to make a determination that a packet is an obsolete packet. Methods of operating such nodes are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

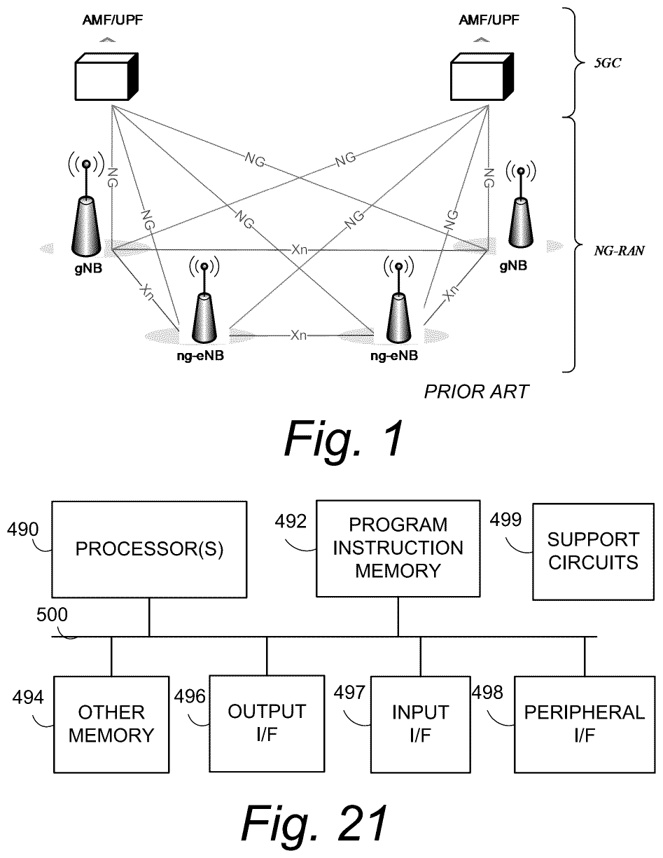

FIG. 2 is a schematic view of selected, basic components of a communications system according to a first example aspect of the technology disclosed herein in which generation and/or transmission of an obsolete packet indication by a transmitter node affects a value stored in a retransmission counter.

FIG. 3A-FIG. 3C are diagrammatic views depicting example aspects of operation of the communications system of FIG. 2 in accordance with various example modes.

FIG. 4 is a schematic view showing in more detail an example implementation of a communications system in which generation and/or transmission of an obsolete packet indication by a transmitter node affects a value stored in a retransmission counter.

FIG. 5 is a schematic view of selected, basic components of a communications system according to a second example aspect of the technology disclosed herein in which generation of an obsolete packet indication message occurs when it has been determined that that a status message received from a receiver node indicates that a packet was not received from the receiver node; and the packet is considered to be an obsolete packet.

FIG. 6 is a diagrammatic view depicting example aspects of operation of the communications system of FIG. 5.

FIG. 7 is a schematic view showing in more detail an example implementation of the communications system of FIG. 5.

FIG. 8 is a schematic view of selected, basic components of a communications system according to a third example aspect of the technology disclosed herein which includes a polling request in an obsolete packet indication message for an obsolete packet.

FIG. 9 is a diagrammatic view depicting an AMD PDU with an 18-bit sequence number.

FIG. 10. is a diagrammatic view depicting an example format of an obsolete packet indication with a polling bit and a single obsolete packet sequence number which may be utilized in conjunction with the example embodiment and mode of FIG. 8.

FIG. 11 is a diagrammatic view depicting an example format of an obsolete packet indication with a polling bit, multiple obsolete packet sequence numbers, and an obsolete packet sequence number range field.

FIG. 12 is a schematic view showing in more detail an example implementation of the communications system of FIG. 8.

FIG. 13 is a schematic view of selected, basic components of a communications system according to a fourth example aspect of the technology disclosed wherein a receiver node makes a determination that a packet is an obsolete packet.

FIG. 14 shows a relationship between FIG. 14A and FIG. 14B, and FIG. 14A and FIG. 14B are diagrammatic views depicting an example of RLC AM receiver operation and state variable updates.

FIG. 15 is a diagrammatic view depicting example operation of a first example implementation of the system of FIG. 13, and particularly operations following the operation of FIG. 14B and illustrating operation of a counter Obsolete_COUNT, including how the counter of the number of t-reassembly expiries with SN<RX_Next_Status_Trigger.

FIG. 16 is a schematic view showing in more detail the first example implementation of the communications system of FIG. 13.

FIG. 17 shows a relationship between FIG. 17A and FIG. 17B, and FIG. 17A and FIG. 17B are diagrammatic views collectively depicting example operation of a second example implementation of the system of FIG. 13, including an example RLC AM receiver with timer-based RX-initiated obsolete SDU determination.

FIG. 18 is a schematic view showing in more detail the second example implementation of the communications system of FIG. 13.

FIG. 19 is a diagrammatic view depicting example operation of a third example implementation of the system of FIG. 13 including an example RLC AM receiver operation with per-SDU timer-based RX-initiated obsolete SDU determination.

FIG. 20 is a schematic view showing in more detail the third example implementation of the communications system of FIG. 13.

FIG. 21 is a diagrammatic view showing example elements comprising electronic machinery which may comprise a wireless terminal, a radio access node, and a core network node according to an example embodiment and mode.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. A wireless terminal communicates with its serving radio access network (RAN)

over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) 24 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having Ims duration similar to LTE. Each subframe consists of 2H slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

5G includes two cell group types: Master Cell Group (MSG) and Secondary Cell Group (SCG). The Master Cell Group is a group of serving cells associated with the Master RAN Node, comprising of the SpCell (Special Cell) which is known as the PCell (Primary Cell) and optionally one or more SCell (Secondary Cell). A PCell is used to initiate the initial access and considered as main cell in MCG. The Secondary Cell Group is a group of serving cells associated with the Secondary RAN Node, comprising of the SpCell which is known as the PSCell (Primary SCell) and optionally one or more SCells. UE might be configured with one or more SCell in connected mode. SCell can be activated or deactivated according to traffic.

### 1.0: Obsolete Packet Indication Affecting Retransmission Counter

If a packet arrives at a buffer of a transmitter, the packet needs to be processed and transmitted to a receiver as soon as possible, to avoid unnecessary delay and potential performance degradation. If there are any outdated packets, those outdated packets can be considered obsolete packets. As used in all aspects of the technology disclosed herein, “packet” is to be construed as including, by way of non-limiting example, a service data unit, SDU, and an obsolete service data unit is an example of an obsolete packet. In Radio Link Control (RLC) Acknowledged Mode (AM), 100% successful delivery is guaranteed regardless of the transmission delay. More specifically, a packet, e.g., an RLC SDU, shall be retransmitted until a positive acknowledgement is received, irrespective of whether the packet is outdated/obsolete. Such retransmission of an obsolete packet, e.g., obsolete service data unit, is an inefficient use of resources.

A reason for the retransmissions of obsolete packets may be the need for window synchronization between the transmitter and the receiver to maintain the same sequence number (SN) range. In other words, if window synchronization is guaranteed, there is no need to retransmit obsolete packets.

Obsolete packets can be defined in various ways, which are explained below with example and non-limiting reference to a packet which is a service data unit, SDU:
In a first non-limiting exemplary embodiment, when an RLC entity receives a discard indication of the SDU from Packet Data Convergence Protocol (PDCP) sublayers, the SDU is considered as an obsolete SDU. The discard indication of the SDU from PDCP sublayer can be sent when PDCP discard timer expires for the SDU. Some other conditions of the discard indication of the SDU can be further defined.
In a second non-limiting, exemplary embodiment, when an RLC entity receives a discard indication of the SDU from PDCP sublayers and the SDU or its SDU segment (part of SDU) was already submitted to the lower layer (i.e. Medium Access Control (MAC) or physical layer), the SDU is considered as an obsolete SDU. The discard indication of the SDU from PDCP sublayer can be sent when PDCP discard timer expires for the SDU. Some other conditions of the discard indication of the SDU can be further defined.
In a third non-limiting, another exemplary embodiment, when an RLC entity receives a discard indication of the SDU from PDCP sublayers and the SDU or its RLC SN cannot be re-assigned to other SDU, the SDU is considered as an obsolete SDU. The discard indication of the SDU from PDCP sublayer can be sent when PDCP discard timer expires for the SDU. Some other conditions of the discard indication of the SDU can be further defined.
In a fourth non-limiting exemplary embodiment, a separate timer can be used to define obsolete SDU. The timer can be started at a pre-defined time instance, for example, packet arrival time at a particular layer, e.g., PDCP or RLC, of the user equipment, UE. The timer length can be configured by an RRC message from gNB, e.g., base station in 5G, to the UE.

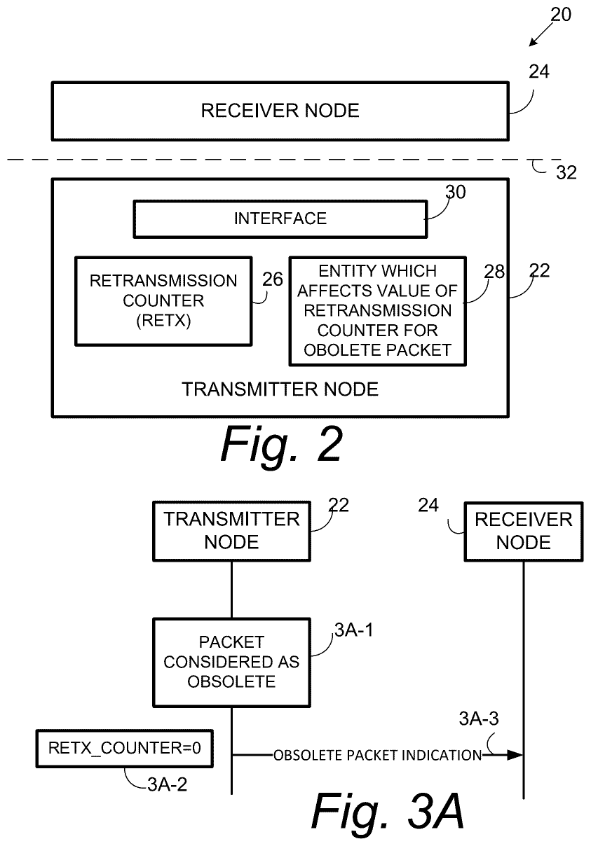

FIG. 2 shows an exemplary embodiment and mode of the technology disclosed herein wherein generation and/or transmission of an obsolete packet indication, e.g., an obsolete packet indication message, OPIM, affects a value stored in a retransmission counter. FIG. 2 shows a communications system 20 comprising transmitter node 22 and receiver node 24. The transmitter node 22 and receiver node 24 may also be referred to as a transmitting node and the receiver node may also be referred to as a receiving node. The transmitter node 22 comprises retransmission counter 26; an entity 28 for affecting a value stored in the retransmission counter 26; and an interface 30, e.g., interface circuitry, for communication over radio or air interface 32 with receiver node 24.

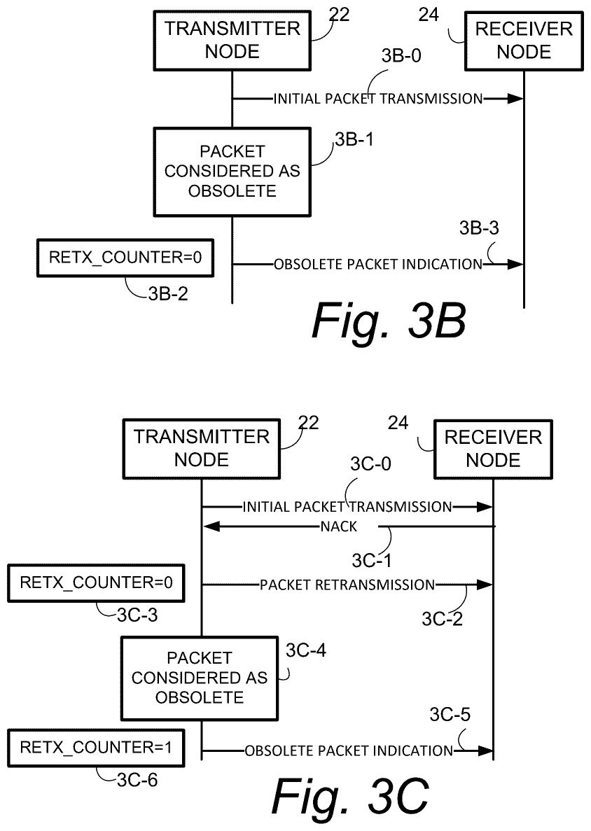

FIG. 3A depicts example acts or steps which may be performed by the communications system 20 of FIG. 2 according to a first mode. For example, in the method of FIG. 3A act 3A-1 comprises the transmitter node 22 making a determination that a packet is an obsolete packet. Act 3A-2 comprises affecting a value of a retransmission counter for the packet when it has been determined that the packet for which a retransmission has been requested is the obsolete packet. Act 3A-2 may be performed by entity 28 of FIG. 2 which may comprise, for example, processor circuitry. Act 3A-3 comprises the transmitter node 22 sending an obsolete packet indication, e.g., an obsolete packet indication message, OPIM, to the receiver node 24.

Thus, as seen in FIG. 3A by act 3A-3, when a packet is considered as an obsolete packet, the transmitter can send an Obsolete Packet Indication message, e.g., OPI message, OPIM, to the receiver, instead of a retransmission of the packet. The information in the Obsolete Packet Indication message includes an indication of which packet is considered obsolete.

Since an obsolete packet indication message is transmitted over a wireless medium, there is a possibility that the message may be lost. If the receiver does not successfully receive the obsolete packet indication message, the receiver does not know the status of the obsolete packet. Thus, the receiver may send an RLC status report including a negative ACK, e.g., NACK, of the SDU indicating that the SDU is not yet received. When the transmitter receives a negative ACK, the transmitter needs to retransmit the Obsolete packet Indication to the receiver or retransmit the obsolete packet itself. However, it is desirable to limit the number of retransmissions for the same SDU. In order to limit the number of retransmissions, a counter value, RETX_COUNT, can be used. In the 3GPP TS 38.322 RLC specification, RETX_COUNT is set to zero at the first retransmission.

FIG. 3A also shows that, in a first example embodiment and mode of the technology disclosed herein a number of retransmission counter, e.g., RETX_COUNT is set to 0 for apacket when the packet is considered as an obsolete packet and the transmitter is about to send the corresponding Obsolete packet Indication to the receiver for the first time. In an exemplary implementation, an event where a packet is considered as an obsolete packet can be called that Obsolete packet indication for the packet is triggered.

In an exemplary implementation, if a packet is considered as an obsolete packet, or an obsolete packet indication message is triggered, the transmitter may consider the corresponding obsolete packet for retransmission. In an exemplary implementation, RETX_COUNT can be set to 0 only if the packet or packet segment is considered for retransmission for the first time among all events that the packet is considered for retransmission, e.g., either it is considered for retransmission by receiving negative ACK or by triggering obsolete packet indication. Thus, as employed in all aspects of the technology disclosed herein, reference to a packet includes a packet segment, e.g., in consideration of retransmission of the packet/packet segment or reception of a packet/packet segment.

If the transmitter is about to retransmit a packet and the packet is an obsolete packet, the transmitter forms an obsolete packet Indication, e.g., an obsolete packet indication message, and submits the obsolete packet indication to the lower layer, e.g., to a medium access control, MAC, or a physical layer.

When the receiver receives an obsolete packet indication, e.g., the obsolete packet Indication, the receiver considers the obsolete packet as if it were successfully received and updates the state variable accordingly.

FIG. 3B depicts example acts or steps which may be performed by the communications system 20 of FIG. 2 according to a second mode. For example, in the method of FIG. 3B act 3B-0 comprises the transmitter node 22 sending an initial transmission of a packet to the receiver node 24. Act 3B-1 comprises the transmitter node 22 making a determination that the packet that was transmitted as act 3B-0 is an obsolete packet.

Act 3B-2 comprises affecting a value of a retransmission counter for the packet when it has been determined that the packet for which a retransmission has been requested is the obsolete packet. Act 3B-2 may be performed by entity 28 of FIG. 2 which may comprise, for example, processor circuitry. Act 3B-3 comprises the transmitter node 22 sending an obsolete packet indication, e.g., an obsolete packet indication message, OPIM, to the receiver node 24 for the packet that was initially transmitted at act 3B-0 and determined to be obsolete at act 3B-1.

Thus, as illustrated by FIG. 3B, when a packet is considered as an obsolete packet, the transmitter can send an obsolete packet indication message to the receiver, instead of retransmission of the packet. The information in the obsolete packet indication message includes an indication of which packet is considered obsolete.

FIG. 3B assumes that, after the initial transmission of a packet or part of packet, e.g., packet segment, was transmitted as shown by act 3B-0, the packet became an obsolete packet. If as a packet is considered as an obsolete packet after the initial transmission of the packet or any packet segment (the packet or any packet segment has been transmitted) as reflected by act 3B-1, as act 3B-3 the RETX_COUNT is set to zero at the first transmission of obsolete packet indication. In an exemplary embodiment, if a packet is considered as an obsolete packet after the initial transmission of the SDU or any SDU segment (the SDU or any SDU segment has been transmitted) as shown by act 3B-2, the transmitter may consider the corresponding obsolete packet for retransmission. In an exemplary embodiment, RETX_COUNT can be set to 0 only if the packet or packet segment is considered for retransmission for the first time among all events that the packet is considered for retransmission, e.g., either it is considered for retransmission by receiving negative ACK or by triggering an obsolete packet indication.

If the transmitter is about to retransmit a packet and the packet is an obsolete packet, the transmitter forms an obsolete packet indication and submits the obsolete packet indication to the lower layer, i.e., the medium access control, MAC, or physical layer.

When the receiver receives an obsolete packet indication, the receiver considers the Obsolete packet as if it was successfully received and updates the state variables accordingly.

FIG. 3C depicts an RLC entity procedure when the transmitter 22, as act 3C-1, receives a negative ACK (NACK) for an obsolete packet. In the example of FIG. 3C, the transmitter 22 transmits a packet to the receiver 24, as an initial transmission as act 3C-0. However, for some reason, the packet was not successfully delivered to the receiver. Based on the receiver operation, a negative Acknowledgement, NACK, for the SDU is transmitted as act 3C-2 from receiver node 24 to the transmitter 22. The NACK information is included in an RLC status report. When the transmitter receives a NACK for the packet, the transmitter considers the packet for retransmission and performs the retransmission as act 3C-2 when a radio resource is given. If the packet or packet segment is considered for retransmission for the first time, the transmitter sets RETX_COUNT to 0 as shown by act 3C-3.

FIG. 3C assumes that, as act 3C-4, the packet is considered as an obsolete packet, after the first retransmission of the packet. Then, as act 3C-5, an obsolete packet indication message is triggered. The transmission of obsolete packet indication can be considered as another retransmission. Thus, as act 3C-6 RETX_COUNT for the packet is incremented by 1, and obsolete packet indication is sent to the receiver. In an exemplary embodiment, the event that an obsolete packet indication is triggered, e.g., the packet is considered as an obsolete packet, makes the transmitter consider the packet for retransmission. If the packet or the packet segment that is considered for retransmission is not pending for retransmission already and the RETX_COUNT associated to the packet has not been incremented due to another negative ACK in the same status report, the transmitter increments RETX_COUNT for the packet by one. Hence, as shown by way of example as act 3C-6, RETX_COUNT now becomes 1.

When the receiver receives an obsolete packet indication, the receiver considers the obsolete packet as if it was successfully received and updates the state variable accordingly.

In an exemplary embodiment, an obsolete packet indication can be prioritized over other packets for initial transmissions.

Thus, in a first example aspect the technology disclosed herein differs from current practice in which RETX_COUNT is set to 0 only if a receiver receives a negative acknowledgement for a packet or packet segment and this is the first retransmission e.g., it is considered for retransmission first time. However, in accordance with a first example aspect of the technology disclosed herein, RETX_COUNT is set to 0 when an obsolete packet indication is triggered. If it is not the first transmission, RETX_COUNT can be incremented by one. When RETX_COUNT reaches the maximum threshold, e.g., maxRetxThreshold, by either retransmission or obsolete packet indication, a radio link failure, RLF, is triggered.

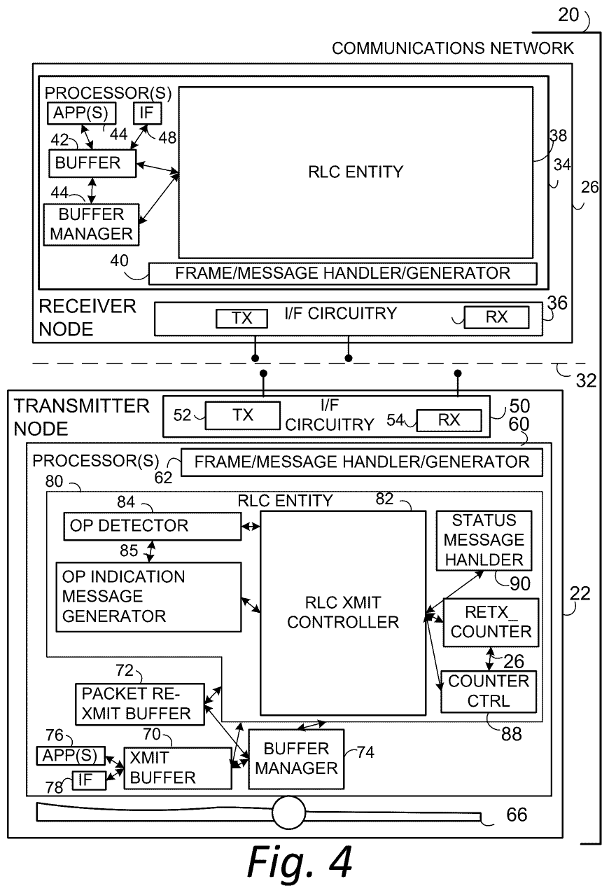

FIG. 4 shows in more detail an example communications system in which the first aspect of the technology disclosed herein may be implemented. The example units and functionalities illustrated in FIG. 4 are not limiting, e.g., various units and functionalities may be omitted in some implementations and other units and functionalities not illustrated herein may be included.

FIG. 4 shows the receiver node 24 comprising receiver node processor circuitry which may comprise one or more receiver node processors 34, as well as receiver node transceiver circuitry 36, which may also be referred to as receiver node interface circuitry. As illustrated in FIG. 4, the receiver node transceiver circuitry 36 may be a transmission and reception point (TRP). The transmission and reception point (TRP) 36 may further comprise transmitter circuitry and receiver circuitry. The receiver node processors 34 may comprise radio link control, RLC, entity 38 and receiver node frame/message handler/generator 40 which prepares and generates information including user data and messages, e.g., signaling, for transmission over the radio interface 32, as which also processes information received over the radio interface 32.

In addition, receiver node 24 may comprise a data buffer or packet buffer 42 into which packets received over radio or air interface 32 from the transmitter node 22 may be stored after post processing by the receiver node 24 and/or packets intended for transmission to the transmitter node 22 may be stored after preparatory processing by receiver node 24. The storage and extraction of packets into/out of packet buffer 42 may be controlled or supervised by buffer manager 44. Packets may be inbound to receiver node 24 from either one or more applications 46 executed by receiver node processors 34, or received from unillustrated higher order or other nodes to which the receiver node 24 may be connected by interface 48.

FIG. 4 also shows various example constituent components and functionalities of transmitter node 22. For example, FIG. 4 shows wireless terminal 30 as comprising transmitter node transceiver circuitry 50, which may also be referred to as transmitter node interface circuitry 50. The transceiver circuitry 50 in turn may comprise transmitter circuitry 52 and receiver circuitry 54. The transmitter node transceiver circuitry 50 may include antenna (c) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 4 further shows transmitter node 22 also comprising transmitter node 22 processor circuitry, e.g., one or more transmitter node processor(s) 60. The transmitter node 22, e.g., transmitter node processor(s) 60, may comprise transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In similar manner to receiver node 24, transmitter node 22 may comprise a data buffer or packet buffer 70 into which packets destined for transmission over radio or air interface 32 from the transmitter node 22 may be stored before pre-processing by the transmitter node 22 and/or packets from receiver node 24 and received at the transmitter node 22 may be stored after post processing by transmitter node 22. The transmitter node 22 may also comprise packet retransmission buffer 72 into which packets, formerly stored and formerly read out of packet buffer 70, may be stored when retransmission is required for such packets. The storage and extraction of packets into/out of packet buffer 72 may be controlled or supervised by buffer manager 74. Packets may be inbound to transmitter node 22 from either one or more applications 76 executed by transmitter node processor(s) 60, or received from unillustrated other nodes to which the transmitter node 22 may be connected by interface 78.

FIG. 4 further shows that transmitter node 22 comprises one or more radio link control (RLC) entities 80. The radio link control (RLC) entity 80 of FIG. 4 is further shown as comprising radio link control packet transmit controller 82, obsolete packet (OP) detector 84; obsolete packet (OP) indication message generator 85, retransmission counter 86, e.g., RETX_counter 26; counter controller 88; and status message handler 90. The radio link control (RLC) entity 80, and thus each of radio link control packet transmit controller 82, obsolete packet detector 84, obsolete packet indication message generator 85, retransmission counter 26, counter controller 88, and status message handler 90 may comprise or be realized by transmitter node processor(s) 60. The counter controller 88 may comprise the entity 28 for affecting a value stored in the retransmission counter 26. The radio link control packet transmit controller 82 may serve to transmit and retransmit packets obtained either from packet buffer 70 or packet retransmission buffer 72 to receiver node 24 via transmitter node transceiver circuitry 50. The status message handler 88 may serve to process status messages, including an acknowledge/negative acknowledgement message received via transmitter node transceiver circuitry 50 from the receiver node 24. The obsolete packet detector 84 may serve to execute acts such as acts 3A-1, 3B-1, and 3C-4 which determine that a packet is an obsolete packet. The obsolete packet indication message generator 85 may serve to prepare an obsolete packet indication message for transmission from transmitter node 22 to receiver node 24. The counter controller 88 may serve to either initialize or increment the value of a count in retransmission counter 86 in accordance with operation such as that above described.

The first example aspect of the technology disclosed herein also encompasses a computer program product in which processor circuitry or the like, such as transmitter node processor(s) 60, execute instructions stored on a non-transient memory to perform acts such as those above described, including the acts of one or more of FIG. 3A through and including FIG. 3C.

### 2.0: Handling Nack of Obsolete Service Data Unit Indication

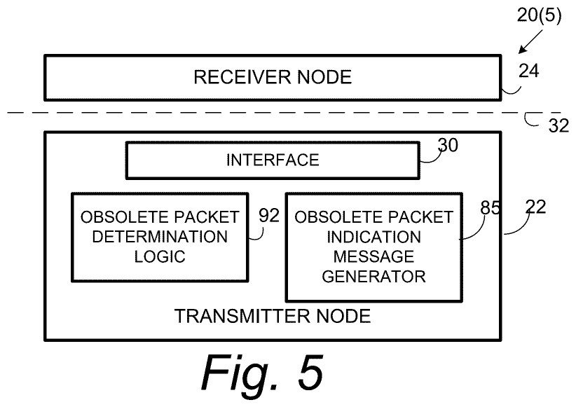

FIG. 5 an exemplary embodiment and mode of a second example aspect of the technology disclosed herein. The example embodiment and mode of the second example aspect generates an obsolete packet indication message, OPIM, that identifies a packet as the obsolete packet when it has been determined that that both (1) a status message received from a receiver node indicates that the packet was not received from the receiver node; and (2) the packet is considered to be an obsolete packet. FIG. 5 shows a communications system 20(5) comprising transmitter node 22 and receiver node 24. The transmitter node 22 and receiver node 24 may also be referred to as a transmitting node and the receiver node may also be referred to as a receiving node. The transmitter node 22 comprises obsolete packet indication message generator 85 and obsolete packet determination logic 92.

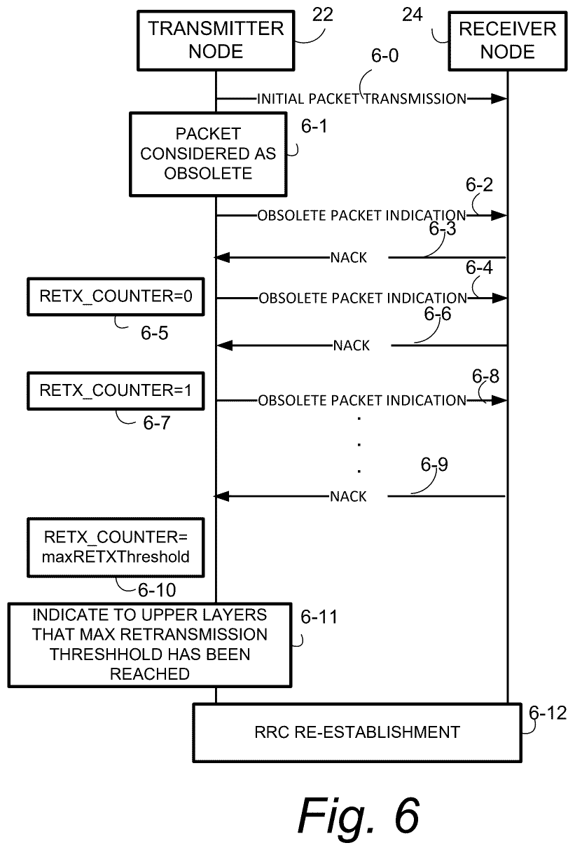

FIG. 6 depicts example acts or steps which may be performed by the communications system 20(5) of FIG. 5. For example, FIG. 6 depicts an RLC entity procedure when the transmitter 22 receives a negative ACK (NACK) for an obsolete packet. In the example of FIG. 6, as act 6-0 the transmitter transmits a packet to the receiver 24, as an initial transmission. After the initial transmission, the packet has become an obsolete packet, so the transmitter considers it as an obsolete packet as shown by act 6-1. So, as act 6-2, an obsolete packet indication is triggered. Meanwhile, for some reason, the obsolete packet indication of act 6-2 is not successfully delivered to the receiver. Based on the receiver operation, as act 6-3 a negative Acknowledgement (NACK) for the packet is transmitted to the transmitter. The NACK information of act 6-3 may be included in an RLC status report. When the transmitter receives the NACK for the obsolete packet, the transmitter considers the packet for retransmission and as act 6-4 performs the retransmission of the obsolete packet indication when a radio resource is given. If the packet or packet segment is considered for retransmission for the first time, as act 6-5 the transmitter sets RETX_COUNT to 0 for the obsolete packet. Act 6-4 shows the transmitter sending an obsolete packet indication to the receiver.

Later, at act 6-6, the transmitter receives a negative ACK again. Since the packet is already an obsolete packet, the transmitter should retransmit the obsolete packet indication to the receiver. The transmission of obsolete packet Indication can be considered as another retransmission. Thus, as act 6-7 RETX_COUNT for the packet is incremented by 1, and as act 6-8 an obsolete packet indication is sent to the receiver. In an exemplary embodiment, the event that an obsolete packet indication is triggered (the packet is considered as an obsolete packet) makes the transmitter consider the packet for retransmission. If the packet or the packet segment that is considered for retransmission is not pending for retransmission already and the RETX_COUNT associated to the packet has not been incremented due to another negative ACK in the same status report, the transmitter increments RETX_COUNT for the packet by one. Hence, RETX_COUNT now becomes 1.

Act 6-9 reflects that multiple negative NACKs for the same packet are transmitted to the transmitter. For each received NACK, the transmitter considers the packet for retransmission and increment RETX_COUNT by 1. If is determined at act 6-10 that the RETX_COUNT reaches the maximum threshold (i.e., maxRetxThreshold), a radio link failure (RLF). As RLF declaration may be performed by the Radio Resource Control (RRC) layer, as act 6-11 the RLC entity indicates to the upper layers, e.g., RRC and other upper layers, that max retransmission has been reached. After the RRC is aware of the RLF, as act 6-12 a RRC Re-establishment procedure is performed between transmitter and receiver.

Thus, in a second example aspect of the technology disclosed herein the reception of a negative ACK for an obsolete packet triggers retransmission of an obsolete packet indication for the packet. In prior art practice, a counter such as RETX_COUNT is set to 0 or incremented by one only if a receiver receives a negative acknowledgement for a packet or packet segment and retransmission of the packet or packet segment is performed. However, according to the second example aspect of the technology disclosed herein, such as the example embodiment and mode of FIG. 5, the reception of a negative ACK triggers a transmission or retransmission of an obsolete packet indication, when the packet is already considered as obsolete. Also, transmission or retransmission of obsolete packet indication can either set RETX_COUNT to 0 or increment it by one. When RETX_COUNT reaches the maximum threshold, e.g., maxRetxThreshold, by either retransmission or an obsolete packetindication, a radio link failure, RLF, is triggered.

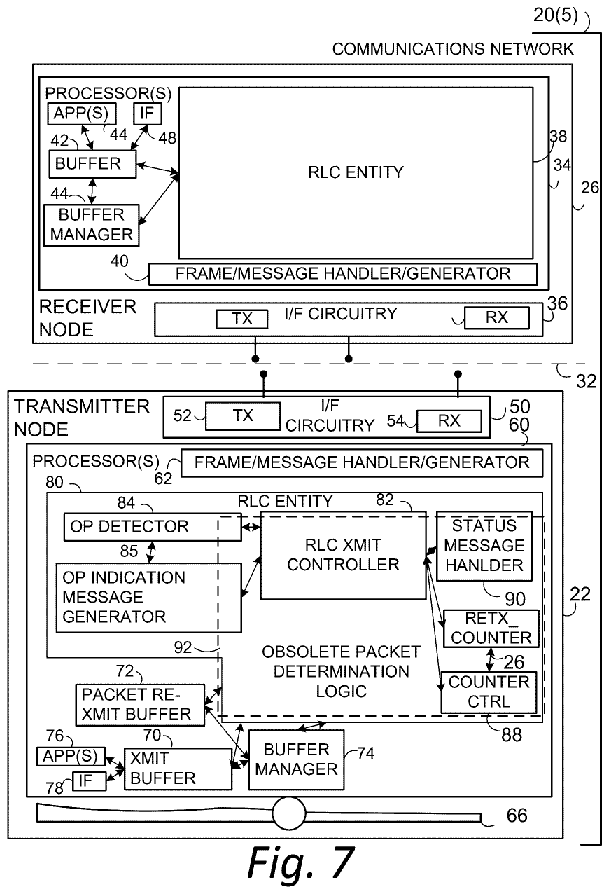

FIG. 7 shows in more detail an example communications system in which the first aspect of the technology disclosed herein may be implemented. The example units and functionalities illustrated in FIG. 7 are not limiting, e.g., various units and functionalities may be omitted in some implementations and other units and functionalities not illustrated herein may be included.

FIG. 7 shows the receiver node 24 comprising receiver node processor circuitry which may comprise one or more receiver node processors 34, as well as receiver node transceiver circuitry 36, which may also be referred to as receiver node interface circuitry. As illustrated in FIG. 7, the receiver node transceiver circuitry 36 may be a transmission and reception point (TRP). The transmission and reception point (TRP) 36 may further comprise transmitter circuitry and receiver circuitry. The receiver node processors 34 may comprise radio link control, RLC, entity 38 and receiver node frame/message handler/generator 40 which prepares and generates information including user data and messages, e.g., signaling, for transmission over the radio interface 32, as which also processes information received over the radio interface 32.

In addition, receiver node 24 may comprise a data buffer or packet buffer 42 into which packets received over radio or air interface 32 from the transmitter node 22 may be stored after post processing by the receiver node 24 and/or packets intended for transmission to the transmitter node 22 may be stored after preparatory processing by receiver node 24. The storage and extraction of packets into/out of packet buffer 42 may be controlled or supervised by buffer manager 44. Packets may be inbound to receiver node 24 from either one or more applications 46 executed by receiver node processors 34, or received from unillustrated higher order or other nodes to which the receiver node 24 may be connected by interface 48.

FIG. 7 also shows various example constituent components and functionalities of transmitter node 22. For example, FIG. 7 shows wireless terminal 30 as comprising transmitter node transceiver circuitry 50, which may also be referred to as transmitter node interface circuitry 50. The transceiver circuitry 50 in turn may comprise transmitter circuitry 52 and receiver circuitry 54. The transmitter node transceiver circuitry 50 may include antenna (e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 7 further shows transmitter node 22 also comprising transmitter node 22 processor circuitry, e.g., one or more transmitter node processor(s) 60. The transmitter node 22, e.g., transmitter node processor(s) 60, may comprise transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In similar manner to receiver node 24, transmitter node 22 may comprise a data buffer or packet buffer 70 into which packets destined for transmission over radio or air interface 32 from the transmitter node 22 may be stored before pre-processing by the transmitter node 22 and/or packets from receiver node 24 and received at the transmitter node 22 may be stored after post processing by transmitter node 22. The transmitter node 22 may also comprise packet retransmission buffer 72 into which packets, formerly stored and formerly read out of packet buffer 70, may be stored when retransmission is required for such packets. The storage and extraction of packets into/out of packet buffer 72 may be controlled or supervised by buffer manager 74. Packets may be inbound to transmitter node 22 from either one or more applications 76 executed by transmitter node processor(s) 60, or received from unillustrated other nodes to which the transmitter node 22 may be connected by interface 78.

FIG. 7 further shows that transmitter node 22 comprises one or more radio link control (RLC) entities 80. The radio link control (RLC) entity 80 of FIG. 7 is further shown as comprising radio link control packet transmit controller 82, obsolete packet (OP) detector 84; obsolete packet (OP) indication message generator 85, retransmission counter 86, e.g., RETX_counter 26; counter controller 88; and status message handler 90. The radio link control (RLC) entity 80, and thus each of radio link control packet transmit controller 82, obsolete packet detector 84, obsolete packet indication message generator 85, retransmission counter 26, counter controller 88, and status message handler 90 may comprise or be realized by transmitter node processor(s) 60. The radio link control packet transmit controller 82 may serve to transmit and retransmit packets obtained either from packet buffer 70 or packet retransmission buffer 72 to receiver node 24 via transmitter node transceiver circuitry 50. The status message handler 88 may serve to process status messages, including an acknowledge/negative acknowledgement message received via transmitter node transceiver circuitry 50 from the receiver node 24.

The status message handler 90 may handle NACKs such as those shown with reference to act 6-3, act 6-6, and act 6-9 of FIG. 6. FIG. 7 shows that the obsolete packet determination logic 92 may comprise or be realized by transmitter node processor(s) 60, including, for example, one or more of radio link control packet transmit controller 82, obsolete packet detector 84, retransmission counter 26, counter controller 88, and status message handler 90. The obsolete packet determination logic 92 may perform one or more acts shown in FIG. 6.

The second example aspect of the technology disclosed herein also encompasses a computer program product in which processor circuitry or the like, such as transmitter node processor(s) 60, execute instructions stored on a non-transient memory to perform acts such as those above described, including the acts of FIG. 6.

### 3.0: Polling for Obsolete Service Data Unit Indication

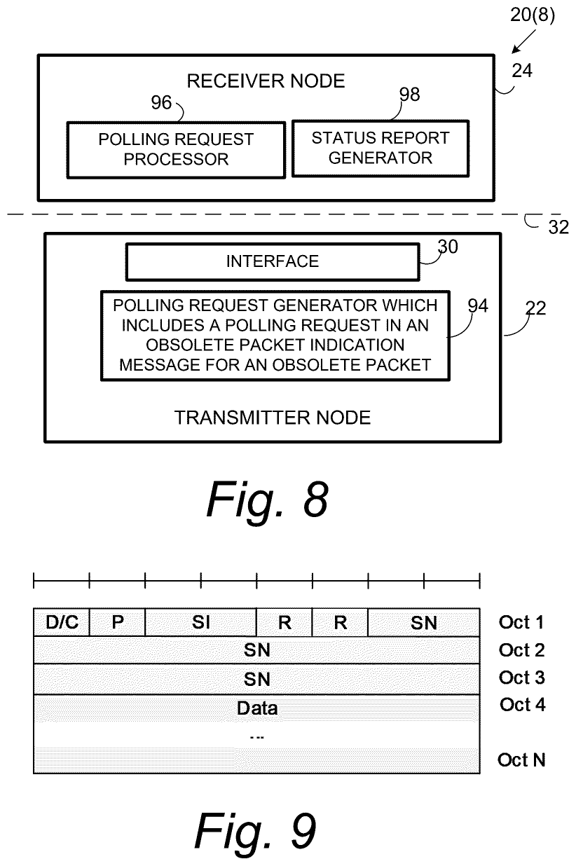

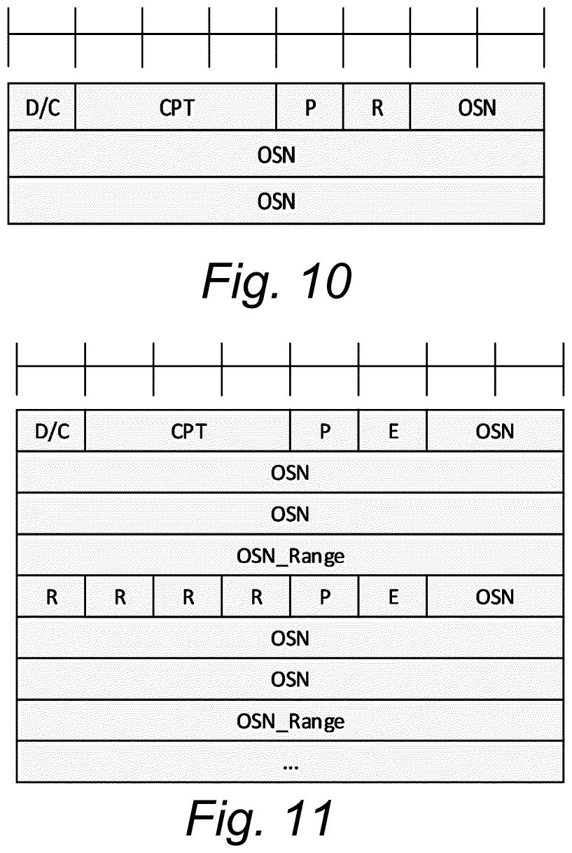

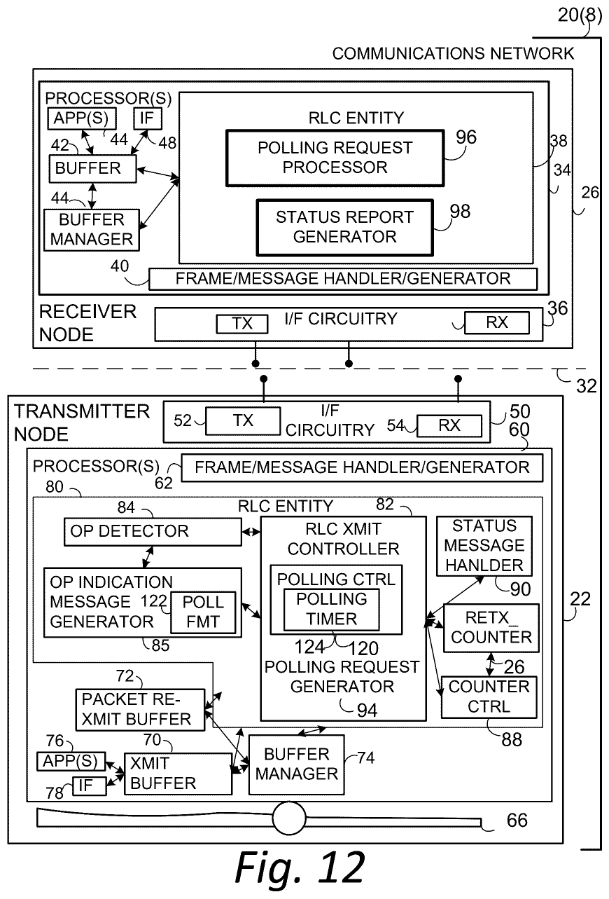

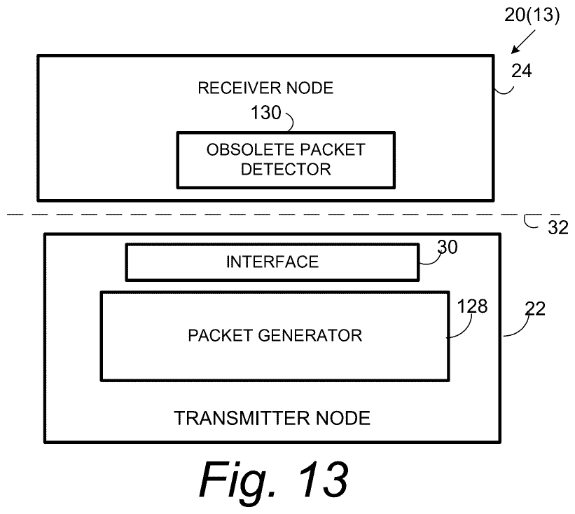

FIG. 8 shows an exemplary embodiment and mode of a third example aspect of the technology disclosed herein. The example embodiment and mode of the third example aspect includes a polling request in an obsolete packet indication message for an obsolete packet. Certain aspects of the operation and system of the third aspect and FIG. 8 are explained below with reference to FIG. 9, FIG. 10, and FIG. 11.

FIG. 8 shows a communications system 20(8) comprising transmitter node 22 and receiver node 24. The transmitter node 22 and receiver node 24 may also be referred to as a transmitting node and the receiver node may also be referred to as a receiving node. The transmitter node 22 comprises polling request generator 94 which is configured to include a polling request in an obsolete packet indication message for an obsolete packet. The transmitter node 22 of FIG. 8 also includes interface circuitry 30 which is further configured to transmit the obsolete packet indication message over a radio interface to a receiver node of the telecommunications system. The receiver node 24 of FIG. 8 comprises polling request processor 96 and status report generator 98.

FIG. 9 depicts an example of AM Data (AMD) PDU format defined in 3GPP TS 38.322. The RLC PDU format may be different depending on SN size, existence of Segment Offset (SO) field, and so on. The example in FIG. 9 assumes 18-bit SN size and no SO field. D/C field, P field, SI field, R field indicates PDU type (either Data (D) or Control (C)), Polling bit to indicate whether to poll, Segment Info meaning how data is segmented, Reserved field, respectively.

In RLC AM, polling is used to request the receiver to provide a status report to the transmitter. A polling bit is included in the header part of RLC PDU. The polling bit is regularly set to 1. More specifically, for the polling a P field is set to one, e.g., “1”, for every pre-configured byte or every pre-configured PDU transmission. Polling can be retransmitted when a timer, for example a timer known as t-PollRetransmit, expires. The timer, e.g., t-PollRetransmit timer, is started or restarted when the transmitter submits an RLC PDU including a poll to the lower layer.

Upon expiry of the timer, e.g., t-PollRetransmit, if (1) both the transmission buffer and the retransmission buffer are empty, excluding transmitted packet or packet segment awaiting acknowledgements, or (2) no new packet or packet segment can be transmitted, e.g., cannot be transmitted due to window stalling, the transmitter can consider the packet with the highest SN among the packets, e.g., RLC SDUs, submitted to lower layer for retransmission or consider any packet which has not been positively acknowledged for retransmission. For the packet or packet segment, the transmitter includes a poll in an AMD PDU. For the technology disclosed herein, and particularly for the technology of the third aspect exemplified by FIG. 8, the term “packet” should be understood to include a packet segment as well as a whole packet.

If all the packets or packet segments in the buffer are obsolete, the retransmission of the packet including a poll bit is only for polling. The retransmission of the packet is a waste of resources. Since an obsolete packet indication does not include any data part, a retransmission of an obsolete packet indication including a polling bit is efficient. Thus, upon expiry of t-PollRetransmit timer, the transmitter can transmit an obsolete packet indication with a poll bit set to one. In an exemplary embodiment and mode, upon expiry of the t-PollRetransmit timer, the transmitter may consider an obsolete packet for retransmission and transmit an obsolete packet indication, e.g., packet sequence number, SN, for the obsolete packet. In an exemplary embodiment of an obsolete packet indication, the packet sequence number, SN, can be associated with the highest RLC SN among RLC SNs reported as obsolete packets in the obsolete packet indication.

FIG. 10 depicts an exemplary, non-limiting format of obsolete packet indication. The example of FIG. 10 assumes that an obsolete packet indication message may include at most one obsolete packet sequence number, OSN, field indicating the sequence number of an obsolete packet. This obsolete packet indication message is a control PDU. A D/C field is set to a bit indicating “control.” A Control PDU Type (CPT) field indicates that this PDU is an obsolete packet indication. A P field indicates polling. An R field is a reserved bit. In the example of FIG. 10, the size of the sequence number, SN, is assumed to be 18 bits.

If the polling bit is set to one, the polling bit can be associated with the sequence number, SN, reported as obsolete packets in the obsolete packet indication message.

FIG. 11 depicts an exemplary format of an obsolete packet indication. The example of FIG. 11 assumes that an obsolete packet indication message can include multiple OSN fields indicating sequence number, SN, of an obsolete packet. This obsolete packet indication message is a control PDU. A D/C field is set to a bit indicating “control.” A Control PDU Type (CPT) field indicates that this PDU is an obsolete packet indication. A P field indicates polling. A R field is a reserved bit. In the example of FIG. 11, the size of the sequence number SN, field, is assumed to be 18 bits. In case that multiple obsolete packets are generated, those obsolete packets are contiguous. In other words, their SNs are continuous. In this case, multiple individual OSN fields increases the size of the obsolete packet indication. To reduce the size, a field shown, for sake of example, as an OSN_Range field can be used to indicate how many consecutive packets from and including the OSN field are involved. An E field indicates the presence of the OSN_Range field. If the E field is set to zero, the OSN_Range field is not present.

If the polling bit is set to one, the polling bit can be associated with the largest sequence number, SN, reported as obsolete packets in the obsolete packet indication message. When a receiver receives an obsolete packet indication including multiple obsolete sequence numbers, SNs, the receiver processes the packets in ascending order of SN. In so doing, the receiver operation includes operation on the state variables of a state machine comprising the RLC entity of the receiver.

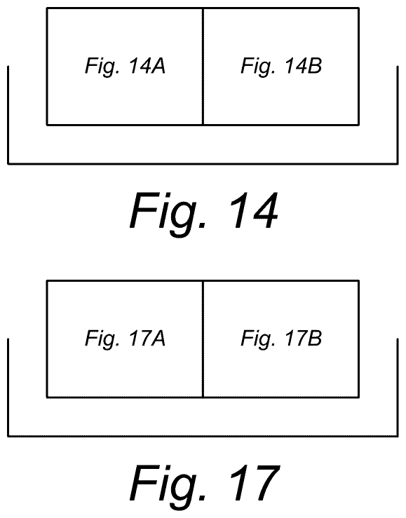

FIG. 12 shows in more detail an example communications system in which the third aspect of the technology disclosed herein may be implemented. The example units and functionalities illustrated in FIG. 12 are not limiting, e.g., various units and functionalities may be omitted in some implementations and other units and functionalities not illustrated herein may be included.

FIG. 12 shows the receiver node 24 comprising receiver node processor circuitry which may comprise one or more receiver node processors 34, as well as receiver node transceiver circuitry 36, which may also be referred to as receiver node interface circuitry. As illustrated in FIG. 12, the receiver node transceiver circuitry 36 may be a transmission and reception point (TRP). The transmission and reception point (TRP) 36 may further comprise transmitter circuitry and receiver circuitry. The receiver node processors 34 may comprise radio link control, RLC, entity 38 and receiver node frame/message handler/generator 40 which prepares and generates information including user data and messages, e.g., signaling, for transmission over the radio interface 32, as which also processes information received over the radio interface 32. The radio link control, RLC, entity 38 of receiver node 24 may comprise the aforementioned polling request processor 96 and status report generator 98.

In addition, receiver node 24 may comprise a data buffer or packet buffer 42 into which packets received over radio or air interface 32 from the transmitter node 22 may be stored after post processing by the receiver node 24 and/or packets intended for transmission to the transmitter node 22 may be stored after preparatory processing by receiver node 24. The storage and extraction of packets into/out of packet buffer 42 may be controlled or supervised by buffer manager 44. Packets may be inbound to receiver node 24 from either one or more applications 46 executed by receiver node processors 34, or received from unillustrated higher order or other nodes to which the receiver node 24 may be connected by interface 48.

FIG. 12 also shows various example constituent components and functionalities of transmitter node 22. For example, FIG. 12 shows wireless terminal 30 as comprising transmitter node transceiver circuitry 50, which may also be referred to as transmitter node interface circuitry 50. The transceiver circuitry 50 in turn may comprise transmitter circuitry 52 and receiver circuitry 54. The transmitter node transceiver circuitry 50 may include antenna (c) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 12 further shows transmitter node 22 also comprising transmitter node 22 processor circuitry, e.g., one or more transmitter node processor(s) 60. The transmitter node 22, e.g., transmitter node processor(s) 60, may comprise transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In similar manner to receiver node 24, transmitter node 22 may comprise a data buffer or packet buffer 70 into which packets destined for transmission over radio or air interface 32 from the transmitter node 22 may be stored before pre-processing by the transmitter node 22 and/or packets from receiver node 24 and received at the transmitter node 22 may be stored after post processing by transmitter node 22. The transmitter node 22 may also comprise packet retransmission buffer 72 into which packets, formerly stored and formerly read out of packet buffer 70, may be stored when retransmission is required for such packets. The storage and extraction of packets into/out of packet buffer 72 may be controlled or supervised by buffer manager 74. Packets may be inbound to transmitter node 22 from either one or more applications 76 executed by transmitter node processor(s) 60, or received from unillustrated other nodes to which the transmitter node 22 may be connected by interface 78.

FIG. 12 further shows that transmitter node 22 comprises one or more radio link control (RLC) entities 80. The radio link control (RLC) entity 80 of FIG. 12 is further shown as comprising radio link control packet transmit controller 82, obsolete packet (OP) detector 84; obsolete packet (OP) indication message generator 85, retransmission counter 86, e.g., RETX_counter 26; counter controller 88; and status message handler 90. The radio link control (RLC) entity 80, and thus each of radio link control packet transmit controller 82, obsolete packet detector 84, obsolete packet indication message generator 85, retransmission counter 26, counter controller 88, and status message handler 90 may comprise or be realized by transmitter node processor(s) 60. The radio link control packet transmit controller 82 may serve to transmit and retransmit packets obtained either from packet buffer 70 or packet retransmission buffer 72 to receiver node 24 via transmitter node transceiver circuitry 50. The status message handler 88 may serve to process status messages, including an acknowledge/negative acknowledgement message received via transmitter node transceiver circuitry 50 from the receiver node 24.

FIG. 12 shows that the polling request generator 94 may comprise or be realized by transmitter node processor(s) 60, including, for example, one or more of radio link control packet transmit controller 82, which in turn may comprise polling controller 120, and obsolete packet indication message generator 85, which in turn may comprise polling bit formatter 122 which serves to include a polling bit in the obsolete packet indication generated by obsolete packet indication message generator 85. The polling controller 120 may comprise, or supervise, a polling timer 124, such as polling timer T-pollRetransmit.

The third example aspect of the technology disclosed herein also encompasses a computer program product in which processor circuitry or the like, such as transmitter node processor(s) 60, execute instructions stored on a non-transient memory to perform acts such as those above described.

Thus, in accordance with the third example aspect of the technology disclosed herein, as generically represented by FIG. 8, the polling request generator 94 of transmitter node 22 may include a polling bit in an obsolete packet indication to indicate to the receiver 24 to trigger a status report. The polling request processor 96 of receiver node 24 may detect and process the polling bit to trigger the status report, while the status report generator 98 may generate the status report. The polling bit may be associated with one of sequence numbers, SNs, reported as obsolete packet's sequence number, SN.

When the polling timer 124, e.g., T-pollRetransmit expires, and if both the transmission buffer and the retransmission buffer are empty, obsolete packet indication with polling bit set to 1 can be transmitted by radio link control packet transmit controller 82.

The third example aspect of the technology disclosed herein thus also involves a format of an obsolete packet indication. The obsolete packet indication format may include one of an obsolete sequence number, SN, e.g., SN of the obsolete packet, an OSN range field, a polling field, and an extension bit to indicate the presence of OSN range field.

When a receiver receives an obsolete packet indication including multiple obsolete sequence numbers, SNs, the receive 24 may process the packet in ascending order of sequence number, SN.

### 4.0: Receiver-Initiated Obsolete Service Data Unit Determination

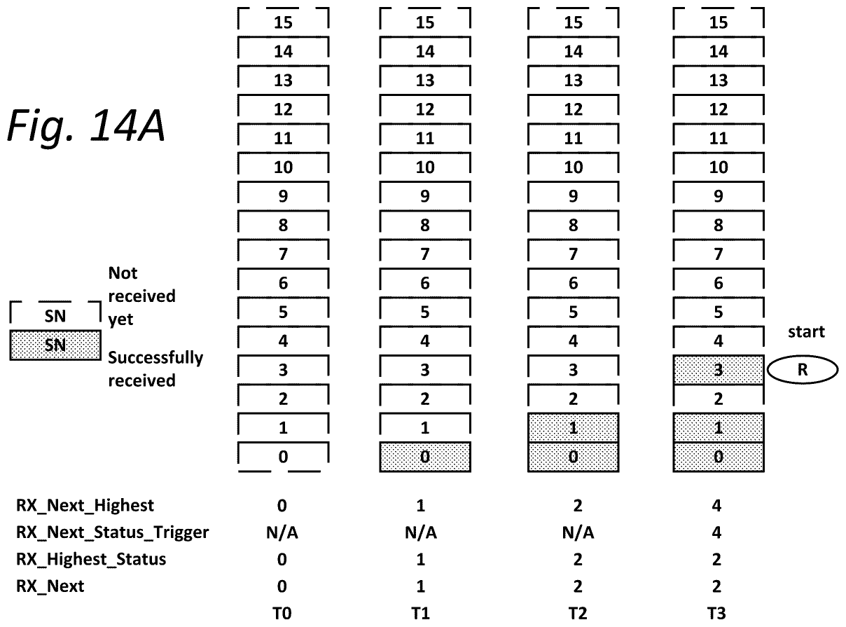

FIG. 13 shows an exemplary embodiment and mode of a fourth example aspect of the technology disclosed herein. In the example embodiment and mode of the fourth example aspect a receiver node makes a determination that a packet is an obsolete packet.

FIG. 13 shows a communications system 20 (13) comprising transmitter node 22 and receiver node 24. The transmitter node 22 and receiver node 24 may also be referred to as a transmitting node and the receiver node may also be referred to as a receiving node. The transmitter node 22 of FIG. 13 includes packet generator 128 and interface circuitry 30. The interface 30 is configured to transmit a packet, or packet segment, over a radio interface to the receiver node 24 of the telecommunications system. The receiver node 24 of FIG. 13 comprises obsolete packet detector 130, which is configured to detect when a packet received from transmitter node 22 is an obsolete packet.

According to 3GPP NR RLC specification TS 38.322, there are four state variables for RLC AM receiver:
a) RX_Next—Receive state variable. This state variable holds the value of the SN following the last in-sequence completely received RLC SDU, and it serves as the lower edge of the receiving window. It is initially set to 0 and is updated whenever the AM RLC entity receives an RLC SDU with SN=RX_Next.
b) RX_Next_Status_Trigger—t-Reassembly state variable. This state variable holds the value of the SN following the SN of the RLC SDU which triggered t-Reassembly.
c) RX_Highest_Status—Maximum STATUS transmit state variable. This state variable holds the highest possible value of the SN which can be indicated by “ACK_SN” when a STATUS PDU needs to be constructed. It is initially set to 0.
d) RX_Next_Highest—Highest received state variable. This state variable holds the value of the SN following the SN of the RLC SDU with the highest SN among received RLC SDUs. It is initially set to 0.

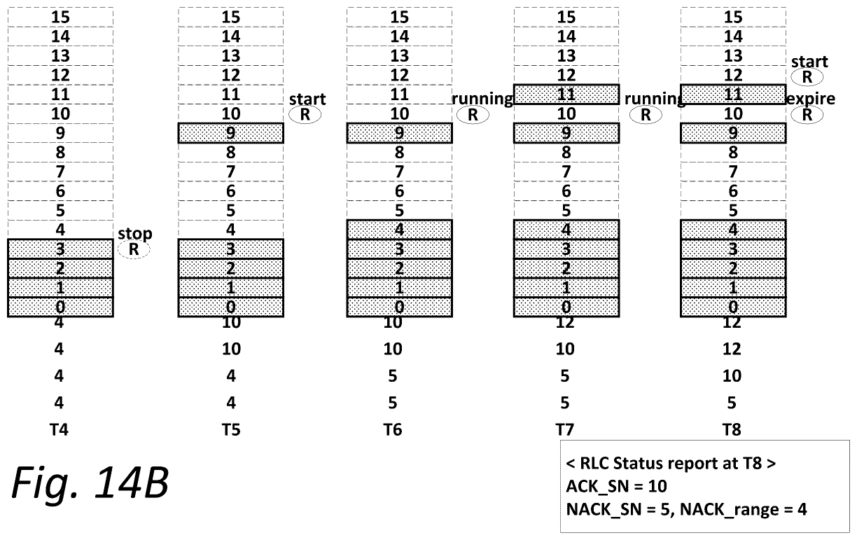

Based on the above discussed four state variables, a receiver RLC entity detects out-of-sequence reception and sends a status report to the transmitter. FIG. 14 shows an example of RLC AM receiver operation and state variable updates based on TS 38.322. In TS 38.322, time Tn is a time sequence but time duration between Tn and Tn+1 is not constant. The TS 38.322 operation as illustrated in FIG. 14 is basically as follows:
At time T0, there is no received SDU and all state variables except RX_Next_Status_Trigger which does not have any initial value are set to the initial value 0.
At time T1, SDU with SN0 (i.e., SDU0) is received. RX_Next_Highest is updated to 1 which is the highest received SN plus 1. RX_Highest_Status is updated to 1 which is the received SN plus 1 and RX_Next is updated to 1 which is the last in-sequence completely received SDU plus 1.
At time T2, SDU1 is received. RX_Next_Highest is updated to 2 which is the highest received SN plus 1. RX_Highest_Status is updated to 2 which is the received SN plus 1 and RX_Next is updated to 2 which is the last in-sequence completely received SDU plus 1.
At time T3, SDU3 is received. RX_Next_Highest is updated to 4 which is the highest received SN plus 1. RX_Highest_Status is not updated, as 3 (the received SN) is not the same as the current RX_Highest_Status. RX_Next is not updated, as 3 (the received SN) is not the same as the current RX_Next. An out-of-sequence detection (SDU2 is missing), so t-reassembly timer (Timer R in the figure) is started and RX_Next_Status_Trigger to 4 which is the current RX_Next_Highest.
At time T4, SDU2 is received. As the received SN is the same as RX_Highest_Status, RX_Highest_Status is updated to 4 which is the SN of the first RLC SDU with SN>current RX_Highest_Status for which not all bytes have been received. RX_Next is updated to 4 which is the SN of the first RLC SDU with SN>current RX_Next for which not all bytes have been received. Now there is no out-of-sequence reception (RX_Next_Status_Trigger=RX_Next), so t-reassembly timer is stopped.
At time T5, SDU9 is received. RX_Next_Highest is updated to 10 which is the highest received SN plus 1. RX_Highest_Status is not updated, as 9 (the received SN) is not the same as the current RX_Highest_Status. RX_Next is not updated, as 9 (the received SN) is not the same as the current RX_Next. An out-of-sequence detection (SDU4 to SDU8 are missing), so t-reassembly timer is started and RX_Next_Status_Trigger to 10 which is the current RX_Next_Highest.
At time T6, SDU4 is received. RX_Next_Highest is not updated as the received SN is smaller than the current RX_Next_Highest. But RX_Highest_Status and RX_Next are updated to 5. RX_Highest_Status is updated to the SN of the first RLC SDU with SN>current RX_Highest_Status for which not all bytes have been received. RX_Next is updated to the SN of the first RLC SDU with SN>current RX_Next for which not all bytes have been received.
At time T7, SDU11 is received. RX_Next_Highest is updated to 12 which is the highest received SN plus 1.
At time T8, t-reassembly timer expired. RX_Highest_Status is updated to 10 which is the SN of the first RLC SDU with SN>=RX_Next_Status_Trigger for which not all bytes have been received. There is another missing SDU (i.e., SDU10), so t-reassembly timer is started again, and RX_Next_Status_Trigger is set to 12, which is the current RX_Next_Highest. An expiry of t-reassembly timer is a condition that the receiver sends a status report to the transmitter. The status report includes ACK_SN value set to 10 which is the current RX_Highest_Status, NACK_SN to 5 and NACK_range to 4 which means that 4 SDUs from and including SDU5 are missing. The transmitter understood that the status report indicates negative ACKs for SDU5, SDU6, SDU7, and SDU8.

In the fourth example aspect of the technology disclosed herein a receiver (RX) may determine whether a packet, e.g., an SDU, is obsolete or not. At the receiver side of RLC entity, out-of-sequence reception of a packet implicitly means that a packet was transmitted at the transmitter but it has not arrived yet at the receiver. If the transmitted packet is not delivered for a long time, the receiver can consider this as an obsolete packet.

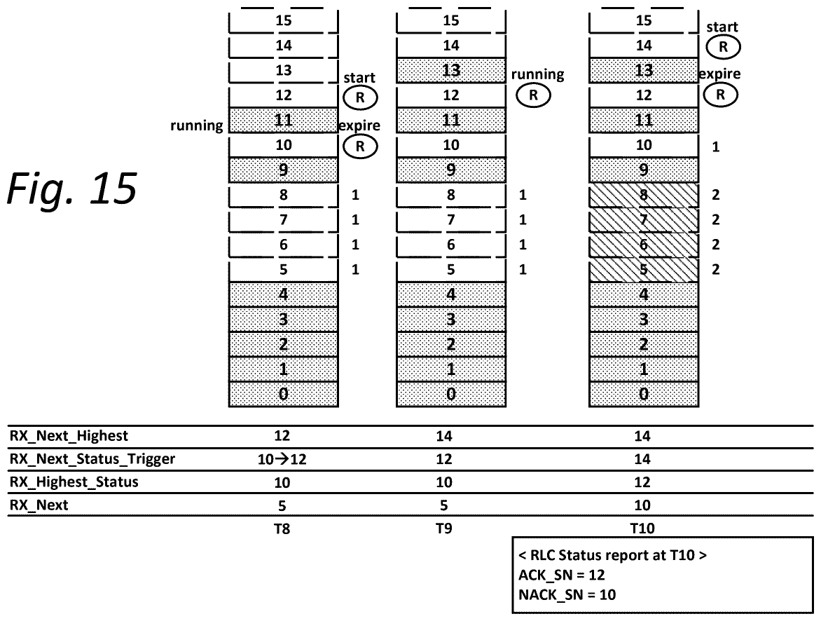

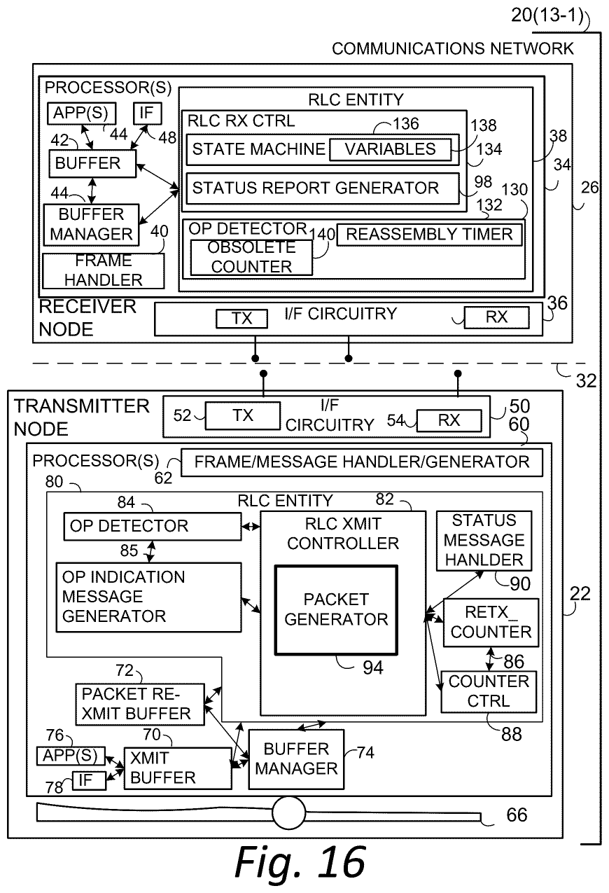

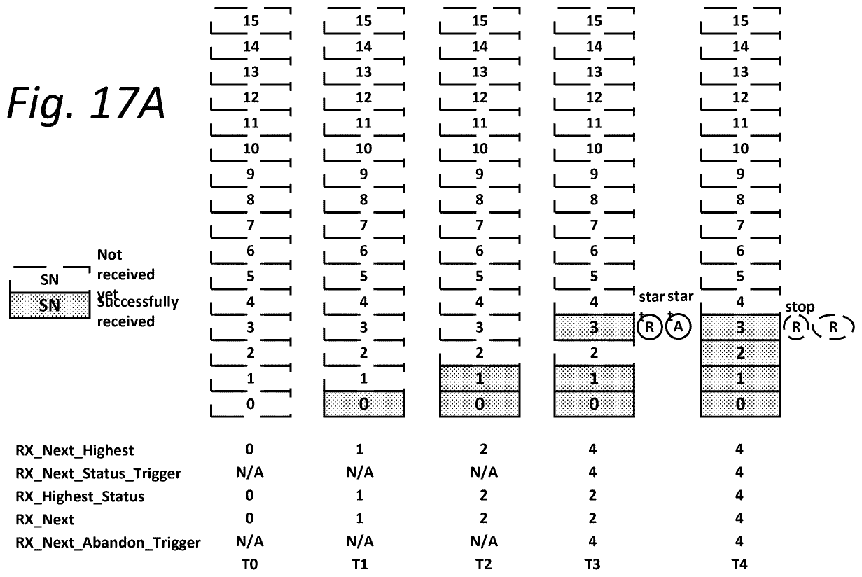

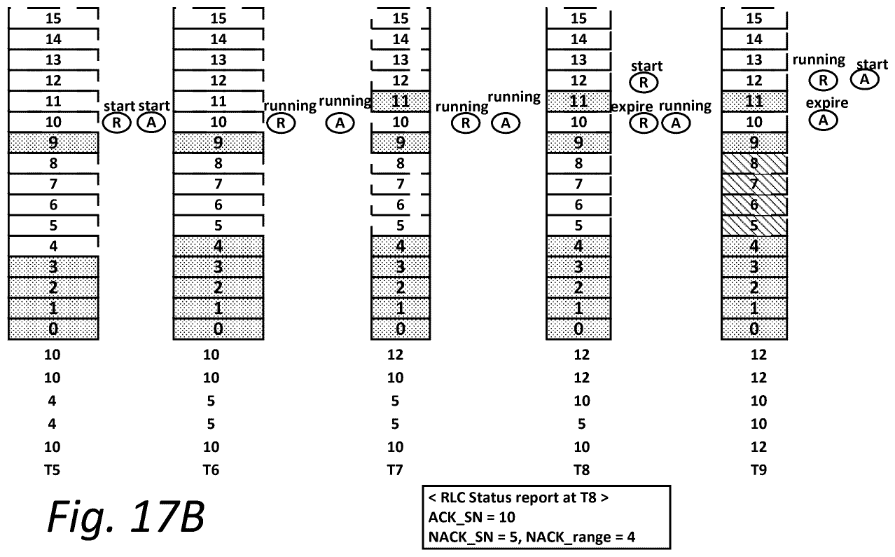

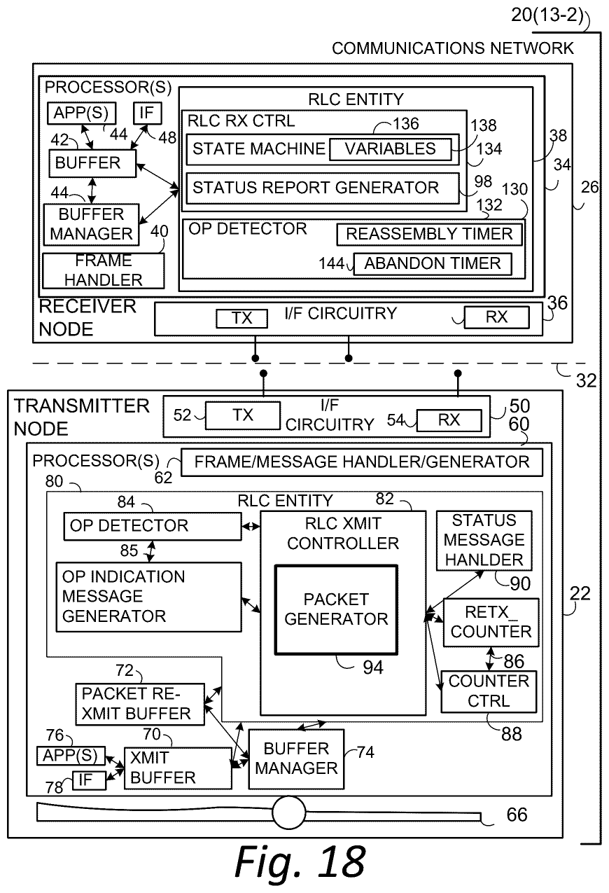

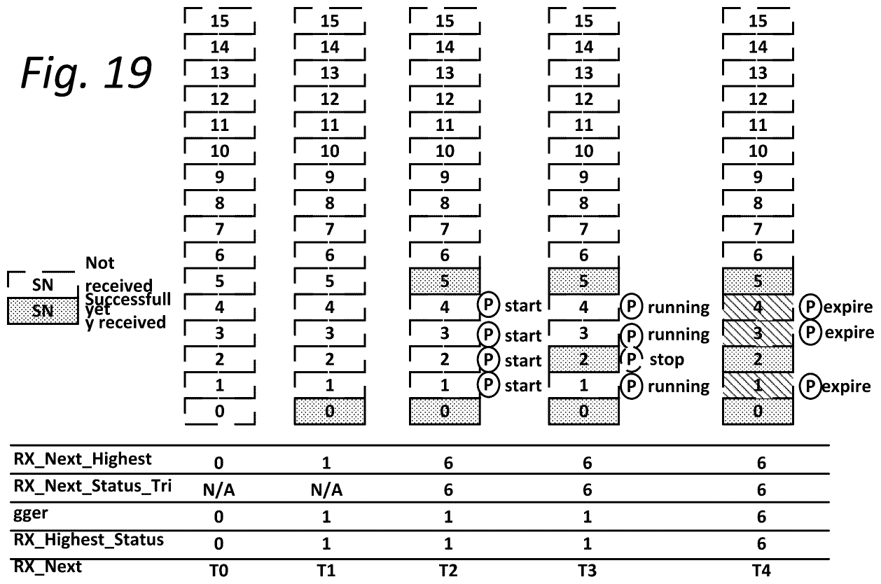

The fourth example aspect of the technology may be implemented according to several variations. Non-limiting examples includes (1) a first implementation, illustrated with example reference to FIG. 15 and FIG. 16, which includes a reassembly timer working with an obsolete counter; (2) a second implementation, illustrated with example reference to FIG. 17A and FIG. 17B and FIG. 18, which includes a reassembly counter working with an abandon timer; and (3) a third implementation, illustrated with example reference to FIG. 19 and FIG. 20, which includes a reassembly timer working with a per packet timer.

### 4.1 First Example Implementation: Obsolete Counter

In a first example and non-limiting illustration implementation, illustrated with reference to FIG. 15 and FIG. 16, a reassembly timer, which may be referred to as t-reassembly timer may be used in RLC AM of receiver node 24 to wait for the missing packet detected by the out-of-sequence detection. Such reassembly timer may be referred to herein and illustrated as reassembly timer 132 or simply timer 132. The reassembly timer 132 works in conjunction with another counter, obsolete counter 140. Both reassembly timer 132 and obsolete counter 140 are illustrated in FIG. 16 and have operations described with reference to FIG. 15.

The expiry of t-assembly timer triggers the receiver, e.g., status report generator 98, to send an RLC status report including acknowledgement information, e.g., either a positive ACK or a negative ACK, whether the SDU is successfully received. When the transmitter 22 receives a status report including a negative ACK for a packet, the transmitter considers the packet for retransmission and performs retransmission of the packet. The duration of t-reassembly timer is determined by considering multiple Hybrid Automatic Repeat Request (HARQ) delays, but the duration of t-reassembly timer can be much shorter than the duration of a PDCP discard timer or the time duration that a packet is considered as obsolete.

An example feature of the fourth example aspect of the technology disclosed herein comprises maintaining a counter value for each packet to check how many times the reassembly timer 132 expires while the state variable RX_Next_Status_Trigger is below the sequence number, SN, of the packet. If the counter value reaches a threshold value, the packet is considered obsolete and the state variable RX_Next is updated to a sequence number greater than the sequence number, SN, of the packet. The counter that maintains the check of how many times the reassembly timer 132 expires while the state variable RX_Next_Status_Trigger is below the sequence number, SN, of the packet is herein called Obsolete_COUNT, or simply counter 140. Other names may be utilized instead. The counter Obsolete_COUNT, may be incremented at the expiry of t-reassembly timer, e.g., reassembly timer 132. In another exemplary embodiment, the counter Obsolete_COUNT may be incremented at the start of t-reassembly timer, instead of the expiry. The threshold value is configured by an RRC message from gNB to the transmitter node 22, which may be a wireless terminal, e.g., UE. The counter Obsolete_COUNT for a packet can be set to 0 at the start of t-assembly that the sequence number, SN, of the packet is smaller than the value of the state variable RX_Next_Status_Trigger. In another exemplary embodiment, the counter Obsolete_COUNT is set to 0 when the RLC entity is established. In another exemplary embodiment, the counter Obsolete_COUNT is set to 0 when the sequence number, SN, falls within the receiving window, e.g., RX_Next<=SN<RX_Next+AM_Window_Size.

As shown in FIG. 16, discussed below, the example receiver node 24 of the fourth example aspect of the technology disclosed herein, as well as other receiver nodes of other aspects, comprises RLC reception controller 134. The RLC reception controller 134 may further comprise RLC state machine 136. The RLC state machine 136 further comprises, or operates in conjunction with, a memory, state machine variable memory 138, which stores state variables for RLC AM receiver, including the state variable described below and other(s) described herein.

FIG. 15 depicts an example to show how the counter, e.g., counter Obsolete_COUNT, also known as obsolete counter 140, or simply counter 140 (see Fig. X), works. The example of FIG. 15 assumes the continuation of FIG. 14B and that t-reassembly timer expires at T8. Also, FIG. 15 assumes that the threshold is 2.
At time T8, immediately before the expiry of t-reassembly timer (or before updating RX_Next_Status_Trigger), RX_Next_Status_Trigger is 10 (It will be updated to 12 later to start the timer again). For each SDU whose SN is smaller than RX_Next_Status_Trigger and for which not all bytes have been received, Obsolete_COUNT is incremented by 1. For SDU5, SDU6, SDU7, SDU8, Obsolete_COUNT is set to 1. Obsolete_COUNT does not reach the threshold which is 2 in this example, there is action.
At time T9, SDU14 is received. RX_Next_Highest is updated to 14 which is the highest received SN plus 1.
At time T10, t-reassembly timer expired. For each SDU whose SN is smaller than RX_Next_Status_Trigger and for which not all bytes have been received, Obsolete_COUNT is incremented by 1. For SDU5, SDU6, SDU7 and SDU8, Obsolete_COUNT is updated to 2, which is the current counter plus 1. For SDU10, Obsolete_COUNT is updated to 1. If the Obsolete_COUNT reaches the threshold, those SDUs are considered obsolete. RX_Next is updated to SN of the first RLC SDU with SN>=RX_Next for which not all bytes have been received and Obsolete_COUNT has not reached the threshold. Thus, the updated RX_Next is 10. RX_Highest_Status is updated to 12 which is the SN of the first RLC SDU with SN>=RX_Next_Status_Trigger for which not all bytes have been received. There is another missing SDU (i.e., SDU12), so t-reassembly timer is started again, and RX_Next_Status_Trigger is set to 14, which is the current RX_Next_Highest. An expiry of t-reassembly timer is a condition that the receiver sends a status report to the transmitter. The status report includes ACK_SN value set to 12 which is the current RX_Highest_Status, NACK_SN to 10 without NACK_range field which means that Only SDU10 is missing. If there are any segments with SN<updated RX_Next in the receiver buffer, all those segments of obsolete SDUs are discarded.

In another exemplary embodiment, if the receiver considers a packet as obsolete, the receiver may consider the packet as successfully received. It leads the receiver operation in case that a packet with the sequence number, SN, is placed in the reception buffer. Also, the receiver discards all segments for the obsolete packet.

As a special case, if the threshold is configured to 1, then at the expiry of t-reassembly timer, a packet for which not all bytes have been received and sequence number, SN, is smaller than value of the state variable RX_Next_Status_Trigger becomes an obsolete SDU.

FIG. 16 shows in more detail an example communications system in which the first example implementation of the third aspect of the technology disclosed herein may be implemented. The example units and functionalities illustrated in FIG. 16 are not limiting, e.g., various units and functionalities may be omitted in some implementations and other units and functionalities not illustrated herein may be included.

FIG. 16 shows the receiver node 24 comprising receiver node processor circuitry which may comprise one or more receiver node processors 34, as well as receiver node transceiver circuitry 36, which may also be referred to as receiver node interface circuitry. As illustrated in FIG. 16, the receiver node transceiver circuitry 36 may be a transmission and reception point (TRP). The transmission and reception point (TRP) 36 may further comprise transmitter circuitry and receiver circuitry. The receiver node processors 34 may comprise radio link control, RLC, entity 38 and receiver node frame/message handler/generator 40 which prepares and generates information including user data and messages, e.g., signaling, for transmission over the radio interface 32, as which also processes information received over the radio interface 32. The radio link control, RLC, entity 38 of receiver node 24 may comprise the aforementioned obsolete packet detector 130, which may in turn comprise reassembly timer 132, and RLC reception controller 134. The RLC reception controller 134 may comprise status report generator 98 and RLC state machine 136 with state machine variable memory 138. The obsolete packet detector 130 may comprise the aforementioned obsolete counter 140.

In addition, receiver node 24 may comprise a data buffer or packet buffer 42 into which packets received over radio or air interface 32 from the transmitter node 22 may be stored after post processing by the receiver node 24 and/or packets intended for transmission to the transmitter node 22 may be stored after preparatory processing by receiver node 24. The storage and extraction of packets into/out of packet buffer 42 may be controlled or supervised by buffer manager 44. Packets may be inbound to receiver node 24 from either one or more applications 46 executed by receiver node processors 34, or received from unillustrated higher order or other nodes to which the receiver node 24 may be connected by interface 48.

FIG. 16 also shows various example constituent components and functionalities of transmitter node 22. For example, FIG. 16 shows wireless terminal 30 as comprising transmitter node transceiver circuitry 50, which may also be referred to as transmitter node interface circuitry 50. The transceiver circuitry 50 in turn may comprise transmitter circuitry 52 and receiver circuitry 54. The transmitter node transceiver circuitry 50 may include antenna (e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 16 further shows transmitter node 22 also comprising transmitter node 22 processor circuitry, e.g., one or more transmitter node processor(s) 60. The transmitter node 22, e.g., transmitter node processor(s) 60, may comprise transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In similar manner to receiver node 24, transmitter node 22 may comprise a data buffer or packet buffer 70 into which packets destined for transmission over radio or air interface 32 from the transmitter node 22 may be stored before pre-processing by the transmitter node 22 and/or packets from receiver node 24 and received at the transmitter node 22 may be stored after post processing by transmitter node 22. The transmitter node 22 may also comprise packet retransmission buffer 72 into which packets, formerly stored and formerly read out of packet buffer 70, may be stored when retransmission is required for such packets. The storage and extraction of packets into/out of packet buffer 72 may be controlled or supervised by buffer manager 74. Packets may be inbound to transmitter node 22 from either one or more applications 76 executed by transmitter node processor(s) 60, or received from unillustrated other nodes to which the transmitter node 22 may be connected by interface 78.

FIG. 16 further shows that transmitter node 22 comprises one or more radio link control (RLC) entities 80. The radio link control (RLC) entity 80 of FIG. 16 is further shown as comprising radio link control packet transmit controller 82 which may include the packet generator 128 shown in FIG. 13. The radio link control (RLC) entity 80 of FIG. 16 may further comprise units and functionalities described with reference to other example aspects, example embodiments and modes described herein.

### 4.2 Second Example Implementation: Abandon Counter

FIG. 17A and FIG. 17B, collectively referred to as FIG. 17, shows an example of RLC AM receiver operation with timer-based RX-initiated obsolete SDU determination. Four existing state variables (RX_Next_Highest, RX_Next_Status_Trigger, RX_Next_Status, RX_Next), which may be stored in state machine variable memory 138, and t-reassembly timer operations are the same as TS 38.322. In the FIG. 17 example, a new timer, known as t-abandon timer or simply abandon timer 144, and a new state variable RX_Next_Abandon_Trigger are included in the operation of detecting obsolete packets. An example implementation of abandon timer 144 is illustrated in FIG. 18 and has operations described with reference to FIG. 17A and FIG. 17B.

More specifically, the expiry of t-abandon timer 144 means that a packet with a sequence number, SN, less than the value of the state variable TX_Next_Abndon_Trigger is considered obsolete. Usually the length of t-abandon timer is assumed to be longer than that of t-reassembly timer 132. However, it is possible that the length of t-abandon timer 134 may be the same as that of t-reassembly timer 132.

The timer 134, e.g., the t-abandon timer, may be started when it is not running and RX_Next_Highest is greater than RX_Next plus one or RX_Next_Highest is equal to RX_Next plus one and there is at least one missing byte segment of the packet associated with SN=RX_Next before the last byte of all received segments of this packet. This means that the timer is started when out-of-sequence reception is detected. RX_Next_Abandon_Trigger is set to RX_Next_Highest.

When t-abandon timer expires, the receiver 24 can update RX_Next to the sequence number, SN, of the first SN>=RX_Abandon_Trigger for which not all bytes have been received. The receiver can discard all segments with SN<updated RX_Next, as those segments will not be used anymore.

When an PDU with SN=x is placed in the buffer, e.g., packet buffer 42, and t-abandon timer is running, if RX_Next_Abandon_Trigger=RX_Next or if RX_Next_Abandon_Trigger=RX_Next+1 and there is no missing byte segment of the packet associated with SN=RX_Next before the last byte of all received segments of this packet or if RX_Next_Abandon_Trigger falls outside of the receiving window and RX_Next_Abandon_Trigger is not equal to RX_Next+AM_Window_Size, the receiver can stop and reset t-abandon timer.

In another exemplary embodiment, the abandon timer 144, e.g., t-abandon timer can be started when it is not running and RX_Next_Highest is greater than RX_Next, i.e., RX_Next_Highest is greater than or equal to RX_Next plus one. This means that the timer is started when a packet transmission is detected. RX_Next_Abandon_Trigger is set to RX_Next_Highest.

When t-abandon timer expires, the receiver can update RX_Next to the sequence number, SN, of the first SN>=RX_Abandon_Trigger for which not all bytes have been received. The receiver can discard all segments with SN<updated RX_Next, as those segments will not be used anymore.

When a packet, e.g., PDU, with SN=x is placed in the buffer and t-abandon timer is running, if RX_Next_Abandon_Trigger=RX_Next, the receiver can stop and reset t-abandon timer.

Example acts of the embodiment and mode of FIG. 17 as provided below. The time Tn is a time sequence but the time duration between Tn and Tn+1 is not constant. As with other figures herein, FIG. 17 may refer to a service data unit, SDU, which should also be understood to be an example of a packet or packet segment.
At time T0, there is no received SDU and all state variables except RX_Next_Status_Trigger and RX_Next_Abandon_Trigger which do not have any initial value are set to the initial value 0.
At time T1, SDU with SN0 (i.e., SDU0) is received. RX_Next_Highest is updated to 1 which is the highest received SN plus 1. RX_Highest_Status is updated to 1 which is the received SN plus 1 and RX_Next is updated to 1 which is the last in-sequence completely received SDU plus 1.
At time T2, SDU1 is received. RX_Next_Highest is updated to 2 which is the highest received SN plus 1. RX_Highest_Status is updated to 2 which is the received SN plus 1 and RX_Next is updated to 2 which is the last in-sequence completely received SDU plus 1.
At time T3, SDU3 is received. RX_Next_Highest is updated to 4 which is the highest received SN plus 1. RX_Highest_Status is not updated, as 3 (the received SN) is not the same as the current RX_Highest_Status. RX_Next is not updated, as 3 (the received SN) is not the same as the current RX_Next. An out-of-sequence detection (SDU2 is missing), so t-reassembly timer (Timer R in the figure) is started and RX_Next_Status_Trigger to 4 which is the current RX_Next_Highest. Also, t-abandon timer (Timer A in the figure) is started and RX_Next_Abndon_Trigger is set to 4 which is the current RX_Next_Highest.
At time T4, SDU2 is received. As the received SN is the same as RX_Highest_Status, RX_Highest_Status is updated to 4 which is the SN of the first RLC SDU with SN>current RX_Highest_Status for which not all bytes have been received. RX_Next is updated to 4 which is the SN of the first RLC SDU with SN>current RX_Next for which not all bytes have been received. Now there is no out-of-sequence reception (RX_Next_Status_Trigger=RX_Next), so t-reassembly timer and t-abandon timer are stopped.
At time T5, SDU9 is received. RX_Next_Highest is updated to 10 which is the highest received SN plus 1. RX_Highest_Status is not updated, as 9 (the received SN) is not the same as the current RX_Highest_Status. RX_Next is not updated, as 9 (the received SN) is not the same as the current RX_Next. An out-of-sequence detection (SDU4 to SDU8 are missing), so t-reassembly timer is started and RX_Next_Status_Trigger to 10 which is the current RX_Next_Highest. Also, t-abandon timer is started and RX_Next_Abandon_Trigger to 10 which is the current RX_Next_Highest.
At time T6, SDU4 is received. RX_Next_Highest is not updated as the received SN is smaller than the current RX_Next_Highest. But RX_Highest_Status and RX_Next are updated to 5. RX_Highest_Status is updated to the SN of the first RLC SDU with SN>current RX_Highest_Status for which not all bytes have been received. RX_Next is updated to the SN of the first RLC SDU with SN>current RX_Next for which not all bytes have been received. Both t-reassembly timer and t-abandon timer are running.
At time T7, SDU11 is received. RX_Next_Highest is updated to 12 which is the highest received SN plus 1. Both t-reassembly timer and t-abandon timer are still running. At time T8, t-reassembly timer expired. RX_Highest_Status is updated to 10 which is the SN of the first RLC SDU with SN>=RX_Next_Status_Trigger for which not all bytes have been received. There is another missing SDU (i.e., SDU10), so t-reassembly timer is started again, and RX_Next_Status_Trigger is set to 12, which is the current RX_Next_Highest. An expiry of t-reassembly timer is a condition that the receiver sends a status report to the transmitter. The status report includes ACK_SN value set to 10 which is the current RX_Highest_Status, NACK_SN to 5 and NACK_range to 4 which means that 4 SDUs from and including SDU5 are missing. The transmitter understood that the status report indicates negative ACKs for SDU5, SDU6, SDU7, and SDU8. But t-abandon timer is still running.
At time T9, t-abandon timer expired. Each SDU whose SN is smaller than RX_Next_Abandon_Trigger and for which not all bytes have been received becomes an obsolete SDU. Thus, the obsolete SDU can be considered as if it was successfully received. Obsolete_COUNT is incremented by 1. SDU5, SDU6, SDU7 and SDU8 become obsolete SDUs. RX_Next is updated to SN of the first non-obsolete RLC SDU with SN>=RX_Next for which not all bytes have been received. In another embodiment, RX_Next is updated to the SN of the first SN>=RX_Abandon_Trigger (before the update, thus RX_Abandon_Trigger is 10 at this time) for which not all bytes have been received. Thus, RX_Next becomes 10. For SDU5, SDU6, SDU7 and SDU8, all their segments less than SN smaller than the updated RX_Next (previous RX_Abandon_Trigger) are discarded. An out-of-sequence detection (SDU10 is missing), so t-abandon timer is started and RX_Next_Abandon_Trigger to 12 which is the current RX_Next_Highest.

In another exemplary embodiment, if the receiver considers a packet as obsolete, the receiver may consider the packet as successfully received. It leads the receiver operation in case that an packet with the sequence number, SN, is placed in the reception buffer. Also, the receiver discards all segments for the obsolete packets.

As a special case, if the length of t-abandon is the same as that of t-reassembly, then at the expiry of t-reassembly timer, a packet for which not all bytes have been received and SN is smaller than RX_Next_Status_Trigger becomes an obsolete packet. RX_Next_Status_Trigger and RX_Next_Abandon_Trigger are the same. In this case, a single state variable can be used instead of two separate state variables.

FIG. 18 shows in more detail an example communications system in which the second example implementation of third aspect of the technology disclosed herein may be implemented. The example units and functionalities illustrated in FIG. 18, like those of FIG. 16, are not limiting, e.g., various units and functionalities may be omitted in some implementations and other units and functionalities not illustrated herein may be included. The structure of FIG. 18 is similar to the structure of FIG. 16 except that the obsolete packet detector 130 of radio link control, RLC, entity 38 of receiver node 24 may comprise the abandon timer 144 in lieu of the obsolete counter 140 of FIG. 16.

### 4.3 Third Example Implementation: Abandon Counter

As another of its example, optional features, the fourth aspect of the technology disclosed herein encompasses a timer operation per packet to determine an obsolete packet. In this case, each packet for which all bytes have not been received has its own timer, a per packet timer 146. The per packet timer 146 is started when its sequence number, SN, is smaller than RX_Next_Highest. In another variation embodiment, the per packet timer 146 can be started when the sequence number, SN, is smaller than RX_Next_Status_Trigger. The per packet timer 146 can be stopped when all byte segments of the packet are successfully received and delivered to the upper layer, e.g., PDCP. If the per packet timer 146 expires, the corresponding packet is considered as obsolete. The receiver can update RX_Next to the SN of the first SN>=RX_Next for which not all bytes have been received and the packet is not considered as obsolete. If a packet becomes obsolete, the receiver discards all segments for the obsolete packet. The receiver can update RX_Highest_Status to the SN of the first SN>=RX_Next for which not all bytes have been received and the packet is not considered as obsolete.

In another example, optional, variation embodiment, if the receiver considers a packet as obsolete, the receiver may consider the packet as successfully received. This leads the receiver operation in case that a packet with the sequence number, SN, is placed in the reception buffer. Also, the receiver discards all segments for the obsolete packet.

Example acts of the embodiment and mode of FIG. 19 are provided below. The time Tn is a time sequence but time duration between Tn and Tn+1 is not constant. As with other figures herein, FIG. 17 may refer to a service data unit, SDU, which should also be understood to be an example of a packet or packet segment.
At time T0, there is no received SDU and all state variables except RX_Next_Status_Trigger which does not have any initial value are set to the initial value 0.
At time T1, SDU with SN0 (i.e., SDU0) is received. RX_Next_Highest is updated to 1 which is the highest received SN plus 1. RX_Highest_Status is updated to 1 which is the received SN plus 1 and RX_Next is updated to 1 which is the last in-sequence completely received SDU plus 1.
At time T2, SDU5 is received. RX_Next_Highest is updated to 6 which is the highest received SN plus 1. RX_Highest_Status is not updated, as 5 (the received SN) is not the same as the current RX_Highest_Status. RX_Next is not updated, as 5 (the received SN) is not the same as the current RX_Next. For SDU1, SDU2, SDU3 and SDU4 and SDU5 whose SN is smaller than RX_Next_Highest (or RX_Next_Status_Trigger), their per SDU timers are started (Timer P in the figure). An out-of-sequence detection (SDU1, SDU2, SDU3, and SDU4 are missing), so t-reassembly timer is started (omitted in the figure) and RX_Next_Status_Trigger to 6 which is the current RX_Next_Highest.
At time T3, SDU2 is received. As SDU2 is received, its per SDU timer for SDU is stopped. No other state variables are changed.
At time T4, per SDU timers for SDU1, SDU3 and SDU4 expires. Those SDUs are considered obsolete. The receiver discards all segments for those SDUs. RX_Next is updated to 6 which is the first SN>=RX_Next for which not all bytes have been received and the SDU is not considered as obsolete. RX_Highest_Status is also updated to 6. If t-reassembly is still running, the timer is also stopped.

FIG. 20 shows in more detail an example communications system in which the third example implementation of third aspect of the technology disclosed herein may be implemented. The example units and functionalities illustrated in FIG. 20, like those of FIG. 16, are not limiting, e.g., various units and functionalities may be omitted in some implementations and other units and functionalities not illustrated herein may be included. The structure of FIG. 20 is similar to the structure of FIG. 16 except that the obsolete packet detector 130 of radio link control, RLC, entity 38 of receiver node 24 may comprise the per packet timer 146 in lieu of the obsolete counter 140 of FIG. 16 or in lieu of the abandon timer 142 of FIG. 18.

All four and other example implementations of the fourth example aspect of the technology disclosed herein also encompasses a computer program product in which processor circuitry or the like, such as receiver node processors 34, execute instructions stored on a non-transient memory to perform acts such as those above described.

Thus, in accordance with one or more variations and optional features of the fourth example aspect of the technology disclosed herein, for each packet, the number of t-reassembly timer 132 expiries is counted at the receiver. If the number of t-reassembly timer expiries that its sequence number (SN) is smaller than RX_Next_Status_Trigger (i.e., Obsolete_COUNT) reaches a threshold value, the packet is considered as an obsolete packet.

The state variable RX_Next is updated larger than the SN of the obsolete packet. More specifically, RX_Next is updated to SN of the first RLC SDU with SN>=RX_Next for which not all bytes have been received and Obsolete_COUNT, e.g., obsolete counter 140, has not reached the threshold. If a packet becomes obsolete, the receiver discards all segments for the obsolete packet. The receiver can update RX_Highest_Status to the SN of the first SN>=RX_Next for which not all bytes have been received and the packet is not considered as obsolete.

In accordance with another example variation, a timer (t-abandon), e.g., abandon timer 144, and a state variable, RX_Next_Abandon_Trigger, are used to detect obsolete packets. More specifically, the expiry of t-abandon timer means that packet with SN less than TX_Next_Abndon_Trigger is considered as obsolete. The t-abandon timer can be started when it is not running and RX_Next_Highest is greater than RX_Next plus one or RX_Next_Highest is equal to RX_Next plus one and there is at least one missing byte segment of the packet associated with SN=RX_Next before the last byte of all received segments of this packet. RX_Next_Abandon_Trigger is set to RX_Next_Highest. When t-abandon timer expires, the receiver can update RX_Next to the SN of the first SN>=RX_Abandon_Trigger for which not all bytes have been received. The receiver can discard all segments with SN<updated RX_Next, as those segments will not be used anymore.

In accordance with another example variation, for each packet whose all bytes have not been received by the receiver, a timer, e.g., per packet timer 146, is used to check whether the packet is obsolete or not. The timer is started when its SN is smaller than RX_Next_Highest. In another optional variation, the timer can be started when the SN is smaller than RX_Next_Status_Trigger.) The timer can be stopped when all byte segments of the packet are successfully received and delivered to the upper layer, e.g., PDCP. If the timer expires, the corresponding packet is considered as an obsolete packet.

The receiver can update RX_Next to the SN of the first SN>=RX_Next for which not all bytes have been received and the packet is not considered as obsolete. If a packet becomes obsolete, the receiver discards all segments for the obsolete packet. The receiver can update RX_Highest_Status to the SN of the first SN>=RX_Next for which not all bytes have been received and the packet is not considered as obsolete.

In terms of wireless communication, the transmitter node 22 may be either a wireless terminal such as user equipment or mobile station, or a network node. Similarly and conversely, the receiver node 24 may be either a wireless terminal such as user equipment or mobile station, or a network node. It should be understood that herein “network” may be used interchangeably with “network node”. A network node may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

A core network may comprise one or more core network nodes. A core network node may comprise or be realized by any suitable type of core network node entities, such as a core network management entity, e.g., an Access and Mobility Management Function (AMF). A core network and one or more of its constituent core network nodes is connected to at least one radio access network through a core-RAN interface circuit. The core-RAN interface circuit may be connected to wireline(s) 28.

A radio access network in turn comprises one or more radio access network (RAN) nodes, such as a base station node. The base station node serves at least one cell. The radio access network, RAN, typically comprises plural access nodes. A base station node may have architecture such as split architecture comprising a central unit and one or more distributed units that comprise mobile termination (MT).

### Further Considerations

It should be understood that the various foregoing example embodiments and modes may be utilized in conjunction with one or more example embodiments and modes described herein. For example, the example embodiments and modes of all four generic aspects of the technology disclosed herein, e.g., FIG. 2, FIG. 5, FIG. 8, and FIG. 13, may be utilized in combination with one or more other example embodiments and modes disclosed herein.

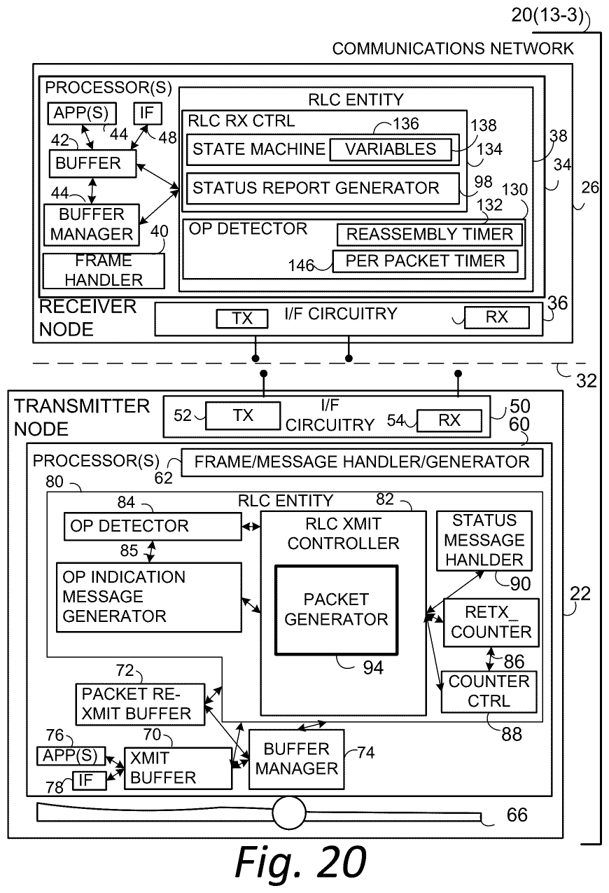

Certain units and functionalities of the communications systems may be implemented by electronic machinery. For example, electronic machinery may refer to the processor circuitry described herein, such as receiver node processors 34 and transmitter node processor(s) 60. Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 21 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, receiver node processors 34 and transmitter node processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein may be performed by a software program product stored tangibly on a non-transient computer-readable medium which, when executed by one or more processors as herein mentioned, performs such acts either in whole or in part. Moreover, each functional block or various features of the transmitter node 22

and receiver node 24 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves resource selection and resource utilization in a communications system.

The technology disclosed herein encompasses one or more of the following non-limiting, non-exclusive example embodiments and modes:

Example Embodiment 1-1: A transmitter node of a telecommunications system, the transmitter node comprising:
a retransmission counter configured to store a value indicative of a number of retransmissions of a packet from the transmitter node to a receiver node of the telecommunications system; and
processor circuitry configured to affect the value of the retransmission counter for the packet when the packet is determined to be an obsolete packet.

Example Embodiment 1-2: The node of Example Embodiment 1-1, wherein the processor circuitry is configured to initialize the value of the retransmission counter when the packet is considered for retransmission for a first time.

Example Embodiment 1-3: The node of Example Embodiment 1-1, wherein the processor circuitry is configured to increment the value of the retransmission counter when the obsolete packet is considered for retransmission for a second or greater retransmission.

Example Embodiment 1-4: The node of Example Embodiment 1-1, wherein the processor circuitry is configured to increment the value of the retransmission counter when the obsolete packet has been considered for retransmission when it was not an obsolete packet.

Example Embodiment 1-5: The node of Example Embodiment 1-1, wherein the processor circuitry is configured to generate a message to an upper layer when the value of the retransmission counter reaches a maximum permitted value and thereby to enable the upper layer to declare a radio link failure.

Example Embodiment 1-6: The node of Example Embodiment 1-1, wherein the packet comprises a service data unit (SDU) and wherein the service data unit is considered to be the obsolete packet upon occurrence of any of the following:
a radio link control (RLC) entity receives a discard indication of the packet from a Packet Data Convergence Protocol (PDCP) sublayer;
the RLC entity receives a discard indication of the service data unit from a PDCP sublayer and the service data unit was already submitted to a lower layer; and
the RLC entity receives a discard indication of the service data unit from the PDCP sublayer and RLC sequence number of the service data unit cannot be re-assigned to another service data unit.

Example Embodiment 1-7: The node of Example Embodiment 1-1, further comprising interface circuitry configured to transmit, over a radio interface to the receiver node of the telecommunications system, a message that identifies the packet as the obsolete packet.

Example Embodiment 1-8: The node of Example Embodiment 1-7, wherein the interface circuitry is configured to transmit the message that identifies the packet as an obsolete packet rather than a retransmission of the packet.

Example Embodiment 1-9: The node of Example Embodiment 1-1, wherein the processor circuitry is configured to affect the value of the retransmission counter when the packet has been determined to be an obsolete packet after an initial transmission of the packet.

Example Embodiment 1-10: The node of Example Embodiment 1-1, wherein the node is a wireless terminal which communicates over a radio interface with a radio access network.

Example Embodiment 1-11: The node of Example Embodiment 1-1, wherein the node is a network node which communicates over a radio interface with a wireless terminal.

Example Embodiment 1-12: A method in a node of a telecommunications system, the method comprising:
maintaining a retransmission counter configured to store a value indicative of a number of retransmissions of a packet from the transmitter node to a receiver node of the telecommunications system; and
affecting the value of the retransmission counter for the packet when the packet is determined to be an obsolete packet.

Example Embodiment 2-1: A transmitter node of a telecommunications system, the node comprising:
interface circuitry configured to receive a status message over a radio interface from a receiver node regarding a packet;
processor circuitry configured:
   to make a determination that both
      (1) the status message indicates that the packet was not received from the receiver node; and
      (2) the packet is considered to be an obsolete packet; and,
   in accordance with the determination, to generate an obsolete packet indication message that identifies the packet as the obsolete packet; and
wherein the interface circuitry is further configured to transmit the obsolete service data unit indication message that identifies the packet as the obsolete service data to the receiver node.

Example Embodiment 2-2: The node of Example Embodiment 2-1, further comprising a retransmission counter for the packet; and wherein the processor circuitry is configured to initialize a value of the retransmission counter for the packet upon at least one of generation and transmission of the obsolete packet indication message for a first time.

Example Embodiment 2-3: The node of Example Embodiment 2-2, wherein if the status message indicates that the obsolete packet indication was not received by the receiver node, the processor circuitry is further configured to increment the value of the retransmission counter and to direct the interface circuitry to retransmit the obsolete packet indication message to the receiver node.

Example Embodiment 2-4: The node of Example Embodiment 2-3, wherein the processor circuitry is configured to generate a message to an upper layer when the value of the retransmission counter reaches a maximum permitted value and thereby enable the upper layer to declare a radio link failure.

Example Embodiment 2-5: The node of Example Embodiment 2-4, wherein upon declaration of a radio link failure the node is configured to perform a radio resource control (RRC) re-establishment procedure.

Example Embodiment 2-6: The node of Example Embodiment 2-1, wherein the node is a wireless terminal which communicates over the radio interface with a radio access network.

Example Embodiment 2-7: The node of Example Embodiment 2-1, wherein the node is a network node which communicates over the radio interface with a wireless terminal.

Example Embodiment 2-8: A transmitter node of a telecommunications system, the node comprising:
processor circuitry configured to generate an obsolete packet indication message that identifies a packet as an obsolete packet when a status message received from a receiver node indicates that the packet was not received from the receiver node and the packet is considered to be an obsolete packet; and,
interface circuitry configured to receive the status message over a radio interface from the receiver node regarding and to transmit the obsolete packet indication message that identifies the packet as the obsolete packet to the receiver node.

Example Embodiment 2-9: The node of Example Embodiment 2-8, further comprising a retransmission counter for the packet; and wherein the processor circuitry is configured to initialize a value of the retransmission counter for the packet upon at least one of generation and transmission of the obsolete packet indication message for a first time.

Example Embodiment 2-10: The node of Example Embodiment 2-9, wherein if the status message indicates that the obsolete packet indication was not received by the receiver node, the processor circuitry is further configured to increment the value of the retransmission counter and to cause the interface circuitry to retransmit the obsolete packet indication message to the receiver node.

Example Embodiment 2-11: The node of Example Embodiment 2-10, wherein the processor circuitry is configured to generate a message to an upper layer when the value of the retransmission counter reaches a maximum permitted value and thereby enable the upper layer to declare a radio link failure.

Example Embodiment 2-12: The node of Example Embodiment 2-11, wherein upon declaration of a radio link failure the node is configured to perform a radio resource control (RRC) re-establishment procedure.

Example Embodiment 2-13: The node of Example Embodiment 2-8, wherein the node is a wireless terminal which communicates over the radio interface with a radio access network.

Example Embodiment 2-14: The node of Example Embodiment 2-8, wherein the node is a network node which communicates over the radio interface with a wireless terminal.

Example Embodiment 2-15: A method in a transmitter node of a telecommunications system, the method comprising:
receiving a status message over a radio interface from a receiver node regarding a packet;
making a determination that both
   (1) the status message indicates that the packet was not received from the receiver node; and
   (2) the packet is considered an obsolete packet; and,
in accordance with the determination, generating an obsolete packet indication message that identifies the packet as the obsolete packet; and
transmitting the obsolete packet indication message that identifies the packet as the obsolete service data to the receiver node.

Example Embodiment 3-1: A transmitter node of a telecommunications system, the node comprising:
processor circuitry configured to include a polling request in an obsolete packet indication message for an obsolete packet; and
interface circuitry configured to transmit the obsolete packet indication message over a radio interface to a receiver node of the telecommunications system.

Example Embodiment 3-2: The node of Example Embodiment 3-1, wherein the processor circuitry is configured to include the polling request in the obsolete packet indication message upon expiration of a polling retransmit timer.

Example Embodiment 3-3: The node of Example Embodiment 3-1, wherein the processor circuitry is configured to include the polling request in the obsolete packet indication message when all packets in a transmission buffer are obsolete packets.

Example Embodiment 3-4: The node of Example Embodiment 3-1, wherein the polling request comprises a predetermined value of a polling bit.

Example Embodiment 3-5: The node of Example Embodiment 3-1, wherein the processor circuitry is configured to generate the obsolete packet indication message to include an indication of a radio link control (RLC) base sequence number which is reported as being an obsolete packet.

Example Embodiment 3-6: The node of Example Embodiment 3-5, wherein the radio link control (RLC) base sequence number is a highest RLC SN among RLC SNs reported as being obsolete packets.

Example Embodiment 3-7: The node of Example Embodiment 3-5, wherein the processor circuitry is configured to generate the obsolete packet indication message to include a range field which indicates a number of consecutive RLC SDUs from the base sequence number that are obsolete packets.

Example Embodiment 3-8: The node of Example Embodiment 3-7, wherein the processor circuitry is configured to generate the obsolete packet indication message to include field which indicates presence of the range field.

Example Embodiment 3-9: The node of Example Embodiment 3-1, wherein the processor circuitry is configured to generate the obsolete packet indication message to not include user application data.

Example Embodiment 3-10: The node of Example Embodiment 3-1, wherein the node is one of (1) a wireless terminal which communicates over the radio interface with a radio access network; and (2) a network node which communicates over the radio interface with a wireless terminal.

Example Embodiment 3-11: A method in a transmitter node of a telecommunications system, the method comprising:
including a polling request in an obsolete packet indication message for an obsolete packet; and
transmitting the obsolete packet indication message over a radio interface to a receiver node of the telecommunications system.

Example Embodiment 3-12: A receiver node of a telecommunications system, the node comprising:
interface circuitry configured to receive an obsolete packet indication message over a radio interface from a transmitter node of the telecommunications system;
processor circuitry configured to determine if a polling request is included in the obsolete packet indication message for an obsolete packet and to process the packet accordingly.

Example Embodiment 3-13: The node of Example Embodiment 3-12, wherein the processor circuitry is configured to determine if a polling request is included in the obsolete packet indication message for a plural number of obsolete packets and to process the plural number of packets accordingly.

Example Embodiment 3-14: The node of Example Embodiment 3-12, wherein the processor circuitry is configured to determine if a polling request includes an indication of a radio link control (RLC) base sequence number which is reported as being an obsolete packet.

Example Embodiment 3-15: The node of Example Embodiment 3-12, wherein the node is one of (1) a wireless terminal which communicates over the radio interface with a radio access network and (2) a network node which communicates over the radio interface with a wireless terminal.

Example Embodiment 4-1: A receiver node of a telecommunications system, the node comprising:
interface circuitry configured to receive packets over a radio interface from a transmitter node of the telecommunications system;
processor circuitry configured to make a determination that a packet is an obsolete packet.

Example Embodiment 4-2: The node of Example Embodiment 4-1, wherein the processor circuitry is configured to make the determination that the packet is the obsolete packet when the packet has not completely been received by the interface circuitry.

Example Embodiment 4-3: The node of Example Embodiment 4-1, wherein the processor circuitry is configured to discard all stored segments of the packet upon making the determination.

Example Embodiment 4-4: The node of Example Embodiment 4-1, wherein upon making the determination the processor circuitry is further configured to update a state variable which holds a value of a sequence number (SN) following the last in-sequence completely received radio link control (RLC) SDU.

Example Embodiment 4-5: The node of Example Embodiment 4-4, wherein the processor circuitry is further configured to update the state variable to a sequence number of a first RLC packet (1) which has a sequence number greater than the current value of the state variable for an packet for which not all bytes have been received and (2) which is not considered as an obsolete packet.

Example Embodiment 4-6: The node of Example Embodiment 4-1, wherein the processor circuitry is configured to make the determination that the packet is the obsolete packet in dependence upon a value of a highest received state variable, and wherein the highest received state variable indicates a value of a sequence number following a sequence number of a radio link control (RLC) packet which as a highest sequence number among received RLC packets.

Example Embodiment 4-7: The node of Example Embodiment 4-6, wherein the processor circuitry is configured to make the determination when the highest received state variable is greater than a sequence number (SN) of the packet for a predetermined time.

Example Embodiment 4-8: The node of Example Embodiment 4-7, wherein the processor circuitry determines the predetermined time with reference to a timer configured to radio link control signaling.

Example Embodiment 4-9: The node of Example Embodiment 4-7, wherein the processor circuitry maintains a separate timer for each of plural packets for which all bytes have not been received.

Example Embodiment 4-10: The node of Example Embodiment 4-1, wherein the processor circuitry is configured to make the determination that the packet is the obsolete packet in dependence upon a counter value for each packet to check how many times a reassembly timer expires while a reassembly timer state variable is below the sequence number of the packet, and wherein the reassembly timer state variable indicates a value of a sequence number following a sequence number of the radio link control (RLC) packet which triggered a reassembly timer.

Example Embodiment 4-11: The node of Example Embodiment 4-1, wherein upon making the determination the processor circuitry is further configured to update a reassembly timer state variable which indicates a value of a sequence number following a SN of the radio link control (RLC) packet which triggered a reassembly timer.

Example Embodiment 4-12: The node of Example Embodiment 4-11, wherein the processor circuitry is further configured to update the reassembly timer state variable to a sequence number greater than a sequence number of the obsolete packet.

Example Embodiment 4-13: A method in a receiver node of a telecommunications system, the method comprising:
receiving packets over a radio interface from a transmitter node of the telecommunications system;
making a determination that a packet is an obsolete packet.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A transmitter node of a telecommunications system, the transmitter node comprising:
a retransmission counter configured to store a value indicative of a number of retransmissions of a packet from the transmitter node to a receiver node of the telecommunications system; and
processor circuitry configured to affect the value of the retransmission counter for the packet when the packet is determined to be an obsolete packet.

2. The node of claim 1, wherein the processor circuitry is configured to initialize the value of the retransmission counter when the packet is considered for retransmission for a first time.

3. The node of claim 1, wherein the processor circuitry is configured to increment the value of the retransmission counter when the obsolete packet is considered for retransmission for a second or greater retransmission.

4. The node of claim 1, wherein the processor circuitry is configured to increment the value of the retransmission counter when the obsolete packet has been considered for retransmission when it was not an obsolete packet.

5. The node of claim 1, wherein the processor circuitry is configured to generate a message to an upper layer when the value of the retransmission counter reaches a maximum permitted value and thereby to enable the upper layer to declare a radio link failure.

6. The node of claim 1, wherein the packet comprises a service data unit (SDU) and wherein the service data unit is considered to be the obsolete packet upon occurrence of any of the following:
a radio link control (RLC) entity receives a discard indication of the packet from a Packet Data Convergence Protocol (PDCP) sublayer;
the RLC entity receives a discard indication of the service data unit from a PDCP sublayer and the service data unit was already submitted to a lower layer; and
the RLC entity receives a discard indication of the service data unit from the PDCP sublayer and RLC sequence number of the service data unit cannot be re-assigned to another service data unit.

7. The node of claim 1, further comprising interface circuitry configured to transmit, over a radio interface to the receiver node of the telecommunications system, a message that identifies the packet as the obsolete packet.

8. The node of claim 1, wherein the interface circuitry is configured to transmit the message that identifies the packet as an obsolete packet rather than a retransmission of the packet.

9. The node of claim 1, wherein the processor circuitry is configured to affect the value of the retransmission counter when the packet has been determined to be an obsolete packet after an initial transmission of the packet.

10. The node of claim 1, wherein the node is a wireless terminal which communicates over a radio interface with a radio access network.

11. The node of claim 1, wherein the node is a network node which communicates over a radio interface with a wireless terminal.

12. A method in a node of a telecommunications system, the method comprising:
maintaining a retransmission counter configured to store a value indicative of a number of retransmissions of a packet from the transmitter node to a receiver node of the telecommunications system; and
affecting the value of the retransmission counter for the packet when the packet is determined to be an obsolete packet.
